(19) United States
(12) Patent Application Publication
(10) Pub. No.: US 2025/0370381 A1
(43) Pub. Date: Dec. 4, 2025

(54) IMAGE FORMING APPARATUS AND INTERMEDIARY TRANSFER UNIT

(71) Applicant: CANON KABUSHIKI KAISHA, Tokyo (JP)

(72) Inventors: YUSUKE ESAKA, Tokyo (JP); TOMOTAKA UEKI, Ibaraki (JP)

(21) Appl. No.: 19/225,595

(22) Filed: Jun. 2, 2025

(30) Foreign Application Priority Data
Jun. 3, 2024 (JP) 2024-090333
Apr. 9, 2025 (JP) 2025-064654

(51) Int. Cl. G03G 15/16; G03G 15/00; G03G 15/01

(52) U.S. Cl. CPC G03G 15/161; G03G 15/0131; G03G 15/0189; G03G 15/1615; G03G 15/5016

(57) ABSTRACT

An image forming apparatus includes an image forming portion and an intermediary transfer unit detachably mountable to a main assembly of the image forming apparatus. The intermediary transfer unit includes a frame unit, a cleaning unit, and a memory substrate. The cleaning unit is detachably mountable to the frame unit. The intermediary transfer unit is detachably mountable to the main assembly in a state in which the cleaning unit is mounted to the frame unit. The memory substrate is provided on the frame unit and includes a storing portion for storing information.

### BACKGROUND

### Field of the Technology

The present disclosure relates to an image forming apparatus, such as a copying machine, a printer, a facsimile machine, or a multi-function machine having a plurality of functions of functions of these machines, using an electrophotographic type or an electrostatic recording type.

### Description of the Related Art

Conventionally, for example, as the image forming apparatus, such as the copying machine, using the electrophotographic type, there is an image forming apparatus employing an intermediary transfer type in which ha toner image formed on an image bearing member is primarily transferred onto an intermediary transfer member and then the toner image is secondarily transferred onto a recording material such as paper. As the intermediary member, an intermediary transfer belt constituted by an endless belt stretched by a plurality of stretching rollers is used in many instances. Further, in the image forming apparatus of the intermediary transfer type, a deposited matter such as toner remaining on the intermediary transfer belt after the toner image is secondarily transferred from the intermediary transfer belt onto the recording material is removed by a belt cleaning device including a cleaning member.

In such an image forming apparatus, in order to maintenance the intermediary transfer belt and the belt cleaning device, an intermediary transfer unit including the intermediary transfer belt and the belt cleaning device is made detachably mountable to an apparatus main assembly of the image forming apparatus in some instances.

Here, a constitution in which a memory substrate is provided to a belt cleaning device and in which new/old discrimination of the belt cleaning device, or the like is made in an apparatus main assembly of an image forming apparatus on the basis of information stored in a memory has been proposed (Japanese Patent Application Laid-Open No. 2022-48958).

Incidentally, an intermediary transfer unit used-up is collected from a market and re-usable parts thereof are re-used, whereby it is possible to provide environment-friendly image forming apparatus and intermediary transfer unit.

However, in the intermediary transfer unit, the belt cleaning device is made further detachably mountable to a frame unit including the intermediary transfer belt in some instances. This is for the purpose of exchanging only the belt cleaning device in the case where a lifetime of the belt cleaning device is shorter than a lifetime of the frame unit, the case where toner on the intermediary transfer belt is not readily removed by the belt cleaning device, or the like case.

In such a constitution, when a memory substrate is mounted to the belt cleaning device, in the case where the belt cleaning device is exchanged, a use history on a frame unit side becomes unknown. The frame unit uses may constituent parts compared with the belt cleaning device, and from a viewpoint of reduction of a load on an environment, it can be said that an advantage of re-utilization of the parts is large.

### SUMMARY

The present disclosure is directed to enable acquisition of information on a use history on a frame unit side even in the case where a belt cleaning device is exchanged in constitution in which the belt cleaning device is detachably mountable to a frame unit of an intermediary transfer unit.

The present disclosure is also directed to simplify a constitution of a connecting portion between a memory substrate on an intermediary transfer unit side and a contact member on an apparatus main assembly side of the image forming apparatus.

The above contents are achieved by an image forming apparatus and an intermediary transfer unit according to the present disclosure.

According to an aspect of the present disclosure, there is provided an image forming apparatus comprising: at least one image forming portion configured to form a toner image on an image bearing member; and an intermediary transfer unit onto which the toner image formed on the image bearing member is transferred and from which the transferred toner image is transferred onto a recording material, the intermediary transfer unit including: a frame unit including an intermediary transfer belt onto which the toner image is transferred from the image bearing member, a plurality of stretching rollers for stretching the intermediary transfer belt, and a frame for supporting the plurality of stretching rollers; a cleaning unit detachably mountable to the frame unit and configured to remove toner from a surface of the intermediary transfer belt; and a memory substrate provided on the frame unit and including a storing portion for storing information.

According to another aspect of the present disclosure, there is provided an image forming apparatus comprising: an image forming portion configured to form a toner image on an image bearing member; and an intermediary transfer unit detachably mountable to a main assembly of the image forming apparatus, onto which the toner image formed on the image bearing member is transferred, and from which the transferred toner image is transferred onto a recording material, the intermediary transfer unit including: an intermediary transfer belt onto which the toner image is transferred from the image bearing member; a plurality of stretching rollers configured to stretch the intermediary transfer belt; a frame configured to support the plurality of stretching rollers; and a memory substrate provided on the frame so as to be disposed outside the intermediary transfer belt with respect to a belt width direction crossing a movement direction of the intermediary transfer belt, and including a storing portion for storing information.

According to another aspect of the present disclosure, there is provided an intermediary transfer unit comprising: a frame unit including an intermediary transfer belt onto which a toner image is transferred, a plurality of stretching rollers for stretching the intermediary transfer belt, and a frame for supporting the plurality of stretching rollers; a cleaning unit detachably mountable to the frame unit and configured to remove toner from a surface of the intermediary transfer belt; and a memory substrate provided on the frame unit and including a storing portion for storing information.

According to a further aspect of the present disclosure, there is provided an intermediary transfer unit comprising: an intermediary transfer belt onto which a toner image is transferred; a plurality of stretching roller configured to stretch the intermediary transfer belt; a frame configured to support the plurality of stretching rollers; and a memory substrate provided on the frame so as to be disposed outside the intermediary transfer belt with respect to a belt width direction crossing a movement direction of the intermediary transfer belt, and including a storing portion for storing information.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic sectional view of an image forming apparatus.

FIG. 2 is a schematic perspective view of an intermediary transfer unit.

FIG. 3 is an enlarged perspective view of a neighborhood of a tension roller of the intermediary transfer unit.

FIG. 4 is a schematic sectional view of the image forming apparatus showing a state in which the intermediary transfer unit is mounted to and demounted from an apparatus main assembly.

FIG. 5 is a schematic perspective view of the intermediary transfer unit showing a state in which a belt cleaning device is demounted from a frame unit.

FIG. 6 is a schematic block diagram showing a control constitution of the image forming apparatus.

FIG. 7 is a schematic view of a neighborhood of the intermediary transfer unit as viewed from above.

FIG. 8 is a perspective view of a front rail.

FIG. 9 is a schematic view for illustrating a tendency of a fluctuation in position of the intermediary transfer unit.

FIG. 10 is an exploded perspective view of the intermediary transfer unit for illustrating assembly of an intermediary transfer unit to a frame.

FIG. 11 is a schematic view of a neighborhood of an intermediary transfer unit in another embodiment as viewed from above.

FIG. 12 is a schematic view of a neighborhood of an intermediary transfer unit in another embodiment as viewed from above.

FIG. 13 is schematic perspective view of an intermediary transfer unit in another embodiment.

FIG. 14 is a schematic perspective view of an intermediary transfer unit in another embodiment.

FIG. 15 is a schematic perspective view of an intermediary transfer unit in another embodiment.

### DESCRIPTION OF THE EMBODIMENTS

An image forming apparatus and an intermediary transfer unit which are according to the present disclosure will be described specifically with reference to the drawings.

### Embodiment 1

### 1. General Constitution and Operation of Image Forming Apparatus

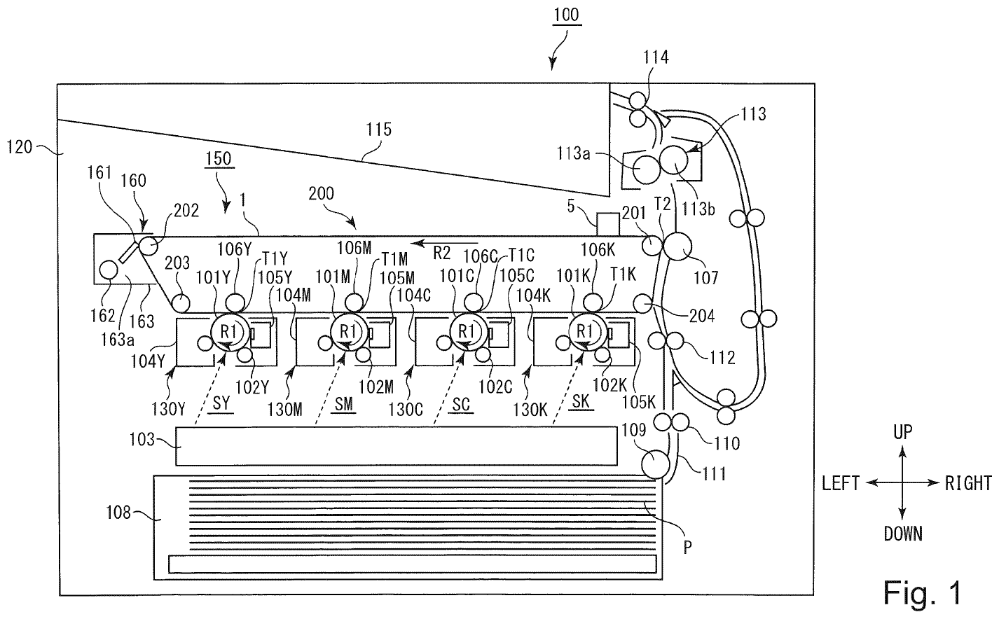

FIG. 1 is a schematic sectional view of an image forming apparatus 100 according to an embodiment 1. The image forming apparatus 100 of this embodiment is a tandem-type full-color printer which is capable of forming a full-color image using an electrophotographic type, and which employs an intermediary transfer type. The image forming apparatus 100 is capable of forming an image on a sheet-like recording material P such as paper depending on an image signal (image information) sent from, for example, an external device such as a personal computer.

Here, as regards the image forming apparatus 100 and elements thereof, a front side of the drawing sheet of FIG. 1 during an operation of the image forming apparatus 100 is referred to as a “front side (front surface side)”, and a rear side of the drawing sheet of FIG. 1 is referred to as a “rear side (rear surface side)”. A front-rear direction (direction perpendicular to the drawing sheet of FIG. 1) is substantially parallel to rotational axis directions of photosensitive drums 101 and stretching rollers 201 to 204 for an intermediary transfer belt 1. Further, as regards the image forming apparatus 100 and the elements thereof, a left side in the case where the image forming apparatus 100 is viewed from the front side is referred to as a “left side”, and a right side in the case where the image forming apparatus 100 is viewed from the front side is referred to as a “right side”. Further, as regards the image forming apparatus 100 and the elements thereof, up and down (upper and lower) refer to up and down (upper and lower) in a direction of gravitation (vertical direction), but do not mean only “immediately above” and “immediately below”, and includes above and below (upper side and lower side) a horizontal surface passing through an attention element or position.

The image forming apparatus 100 includes, as a plurality of image forming portions, four image forming portions SY, SM, SC and SK for forming toner images of yellow (Y), magenta (M), cyan (C) and black (K), respectively. As regards elements having the same or corresponding functions or constitutions, suffixes Y, M, C and K for representing elements for associated colors are omitted, and the elements will be collectively described in some instances. In this embodiment, the image forming portion S is constituted by including a photosensitive drum 101, a charging roller 102, an exposure device 103, a developing device 104, a drum cleaning device 105, and the like, which are described later. In this embodiment, the exposure device 103 is constituted as a single unit for exposing the photosensitive drum 101 of each image forming portion S but may also be provided independently for each image forming portion S.

The photosensitive drum 101 which is a drum-shaped (cylindrical) photosensitive member (electrophotographic photosensitive member) as an image bearing member is rotationally driven in an arrow R1 direction (clockwise direction) in FIG. 1 at a predetermined peripheral speed (process speed). A surface (outer peripheral surface) of the rotating photosensitive drum 101 is electrically charged uniformly to a predetermined polarity (negative polarity in this embodiment) and to a predetermined potential by the charging roller 102 as a charging means. The charged surface of the photosensitive drum 101 is subjected to scanning exposure to light depending on an image signal by the exposure device (laser scanner) 103 as an exposure means, so that an electrostatic latent image (electrostatic image) is formed on the photosensitive drum 101.

The electrostatic latent image formed on the photosensitive drum 101 is developed (visualized) by being supplied with toner as a developer by the developing device 104 as a developing means, so that a toner image is formed on the photosensitive drum 101. In this embodiment, on an exposure portion (image portion) on the photosensitive drum 101 lowered in absolute value of a potential through exposure after being uniformly charged, toner charged to the same polarity (negative polarity in this embodiment) as the charge polarity of the photosensitive drum 101 is deposited (reverse development type). In this embodiment, a normal charge polarity of the toner which is a principal toner charge polarity during development is the negative polarity.

An intermediary transfer belt 1 constituted by an endless belt as an intermediary transfer member is provided so as to oppose the four photosensitive drums 101Y, 101M, 101C and 101K. The intermediary transfer belt 1 is extended and stretched at a predetermined tension by, as a plurality of stretching rollers, a driving roller 201, a tension roller 202, a first auxiliary roller 203, and a second auxiliary roller 204. The intermediary transfer belt 1 is driven by inputting a driving force to the driving roller 201, so that the intermediary transfer belt 1 is rotated (moved and circulated) in an arrow R2 direction (counterclockwise direction) in FIG. 1 at a peripheral speed (process speed) which is the same as the peripheral speed of the photosensitive drum 101. The tension roller 202 imparts a predetermined tension to the intermediary transfer belt 1. The first and second auxiliary rollers 203 and 204 form a substantially flat primary transfer surface of the intermediary transfer belt 1 onto which the toner image is primarily transferred from each of the photosensitive drums 101. Incidentally, the number of the rollers stretching the intermediary transfer belt 1 is not limited to four. On an inner peripheral surface side of the intermediary transfer belt 1, correspondingly to the respective photosensitive drums 101Y, 101M, 101C, and 101K, primary transfer rollers 106Y, 106M, 106C, and 106K which are roller-type primary transfer members as primary transfer means are provided, respectively. Each of the primary transfer rollers 106 urges (presses) an inner peripheral surface of the intermediary transfer belt 1 toward the associated photosensitive drum 101. By this, a primary transfer portion (primary transfer nip) T1 which is a contact portion between the photosensitive drum 101 and the intermediary transfer belt 1 is formed. Of the plurality of stretching rollers, the stretching rollers other than the driving roller 201 and the respective primary transfer roller 106 are rotated with rotation of the intermediary transfer belt 1.

The toner image formed on the photosensitive drum 101 is transferred (primarily transferred) in the primary transfer portion T1 onto the rotating intermediary transfer belt 1 by applying thereto a predetermined pressing force and an electrostatic load bias. During the primary transfer, to the primary transfer roller 106, a primary transfer voltage (primary transfer bias) which is a DC voltage of an oppose polarity (positive polarity in this embodiment) to the normal charge polarity of the toner is applied by a primary transfer voltage source which is a high-voltage source (not shown). For example, during full-color image formation, the toner images, of the respective colors of yellow, magenta, cyan and black, formed on the respective photosensitive drums 101 are successively transferred superposedly onto the intermediary transfer belt 1. The image forming processes for the respective colors which are processed in parallel by the respective image forming portions S are performed at timings each when the toner image is primarily transferred on a downstream side onto the intermediary transfer belt 1 on which the toner image has already been primarily transferred on an upstream side. Incidentally, the number of the image forming portions S is not limited to four, and the order of arrangement of the image forming portions S for the respective colors is also not limited to the order of arrangement in this embodiment.

On an outer peripheral surface side of the intermediary transfer belt 1, in a position opposing the driving roller 201, an outer secondary transfer roller (transfer roller) 107 which is a roller-type secondary transfer member as a secondary transfer means is provided. The driving roller 201 also functions as an inner secondary transfer roller (opposite roller) as an opposing member. The outer secondary transfer roller 107 is urged (pressed) toward the driving roller 201 and applies an external force to the driving roller 201 via the intermediary transfer belt 1. By this, a secondary transfer portion (secondary transfer nip) T2 which is a contact portion between the intermediary transfer belt 1 and the outer secondary transfer roller 107 is formed. In this embodiment, the outer secondary transfer roller 107 is rotated with rotation of the intermediary transfer belt. Incidentally, the image forming apparatus 100 may have a constitution in which the outer secondary transfer roller 107 is driven and rotated. The toner images formed on the intermediary transfer belt 1 are transferred (secondarily transferred), in the secondary transfer portion T2, onto a recording material P nipped and fed by the intermediary transfer belt 1 and the outer secondary transfer roller 107, by applying thereto a predetermined pressing force and an electrostatic load bias. During the secondary transfer, to the outer secondary transfer roller 107, a secondary transfer voltage (secondary transfer bias) which is a DC voltage of the opposite polarity (positive polarity in this embodiment) to the normal charge polarity of the toner is applied by a secondary transfer voltage source (not shown). The driving roller 201 is electrically grounded. Incidentally, a constitution in which the secondary transfer voltage is applied to the inner secondary transfer roller as the secondary transfer member corresponding to the driving roller 201 and in which the outer secondary transfer roller as the opposing member corresponding to the outer secondary transfer roller 107 in this embodiment is electrically grounded may be employed. In this case, during the secondary transfer, a secondary transfer voltage of the same polarity as the normal charge polarity of the toner is applied to the inner secondary transfer roller.

The recording materials (sheets, transfer materials, recording media) P are stacked and accommodated in a recording material cassette 108 as a recording material accommodating portion. The recording materials P accommodated in the recording material cassette 108 are fed one by one from the recording material cassette 108 by a feeding roller 109 or the like which is a feeding member as a feeding means. The recording material P fed from the recording material cassette 108 is conveyed to a registration roller pair 112 which is a conveying member as a conveying means by a conveying roller pair 110 or the like which is conveying member as a conveying means through a conveying path 111. This recording material P is subjected to correction of oblique movement by the registration roller pair 112 and thereafter is conveyed to the secondary transfer portion T2 by being timed to the toner images on the intermediary transfer belt 1.

The recording material P on which the toner images are transferred is conveyed to a fixing device 113 as a fixing means. The fixing device 113 heats and presses the recording material P, on which the unfixed toner images are carried, by a fixing roller 113a provided with a heat source and by a pressing roller 113b press-contacted to the fixing roller 113a while conveying the recording material P, so that the toner images are fixed (melted, stuck) on the recording material P. The recording material P on which the toner images are fixed is discharged (outputted) to a discharge tray 115, provided to an outside of an apparatus main assembly 120 of the image forming apparatus 100, by a discharging roller pair 114 or the like.

On the other hand, toner (primary transfer residual toner) remaining on the photosensitive drum 101 after the primary transfer step is removed and collected from the photosensitive drum 101 by a drum cleaning device 105 as a photosensitive member cleaning means. Further, deposited matters such as toner (secondary transfer residual toner) and paper powder which are remaining on the intermediary transfer belt 1 after the secondary transfer step are removed and collected from the intermediary transfer belt 1 by a belt cleaning device 160 as an intermediary transfer member cleaning means. Collected matters such as the toner and paper powder collected by the drum cleaning device 105 and the belt cleaning device 160 are conveyed and collected into a residual toner collecting container (not shown) provided in the apparatus main assembly 120 via a residual toner conveying passage (not shown) provided in the apparatus main assembly 120.

In this embodiment, at each of the image forming portions S, the photosensitive drum 101, the charging roller 102, the developing device 104 and the drum cleaning device 105 integrally constitute a process cartridge 130 detachably mountable to the apparatus main assembly 120.

Further, in this embodiment, the intermediary transfer belt 1, the stretching rollers 201 to 204, the primary transfer rollers 106, and the belt cleaning device 160 integrally constitute an intermediary transfer unit 150 detachably mountable to the apparatus main assembly 120. The intermediary transfer unit 150 will be further described later.

Incidentally, in this embodiment, the apparatus main assembly 120 corresponds to a portion other than the process cartridges 130 and the intermediary transfer unit 150 in the image forming apparatus 100.

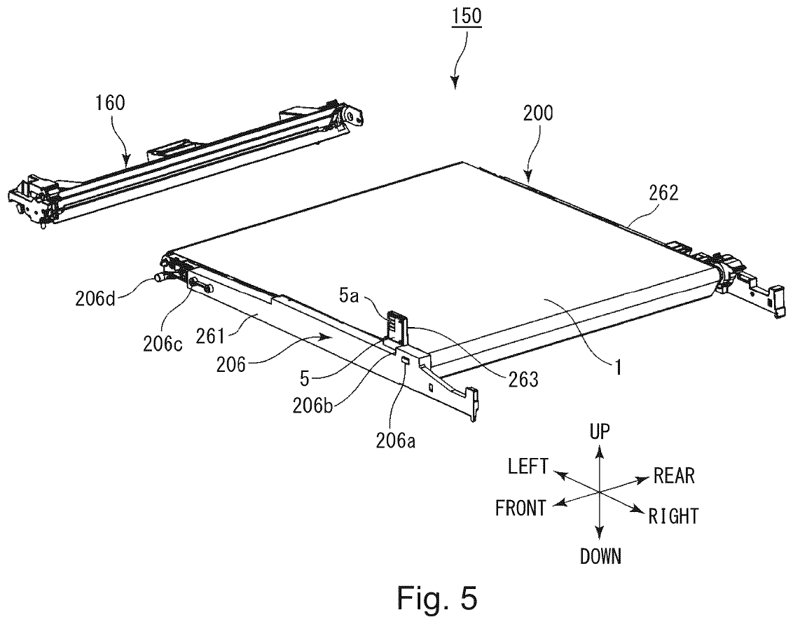

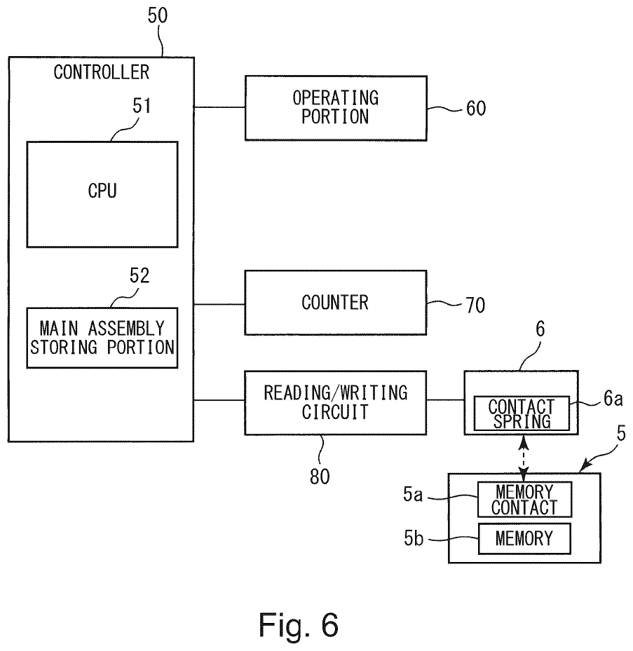

In this embodiment, at a position of a medium stage of the apparatus main assembly 120 with respect to an up-down direction, the intermediary transfer unit 150 is disposed detachably mountable. The intermediary transfer unit 150 is supported by a front rail 10F and a rear rail 10R (FIGS. 5 and 6) which are rail-shaped mounting portions provided on a frame on opposite end portion sides in the apparatus main assembly 120 with respect to a widthwise direction of the intermediary transfer belt 1 during mounting thereof into the apparatus main assembly 120.

Incidentally, the widthwise direction of the intermediary transfer belt 1 is a direction substantially perpendicular to a surface movement direction of the intermediary transfer belt 1 and is a direction substantially parallel to rotational axis directions of the stretching rollers 201 to 204. When the intermediary transfer unit 150 is mounted in the apparatus main assembly 120, the belt cleaning device 160 provided to the intermediary transfer unit 150 is connected to a residual toner conveying passage (not shown) provided in the apparatus main assembly 120. Mounting and demounting of the intermediary transfer unit 150 relative to the apparatus main assembly 120 will be described specifically later. Further, in this embodiment, in a portion under the intermediary transfer unit 150, the four process cartridges 130Y, 130M, 130C and 130K are disposed from an upstream side toward a downstream side along a movement direction of the primary transfer surface of the intermediary transfer belt 1. In this embodiment, an arrangement direction of the four image forming portions (photosensitive drums 101) in substantially horizontal. That is, in this embodiment, a common contact flat surface on a side where the four photosensitive drums 101 contact the intermediary transfer belt 1 is substantially horizontal.

### 2. Intermediary Transfer Belt Unit

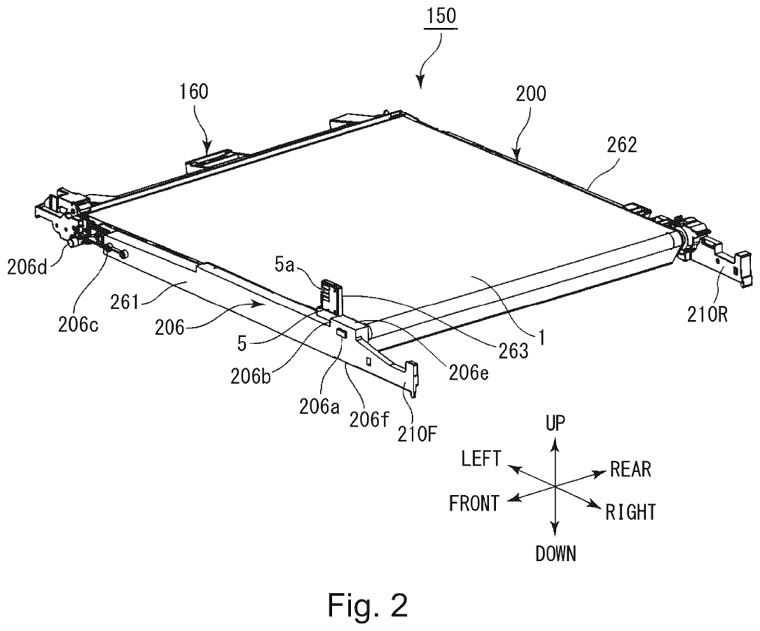

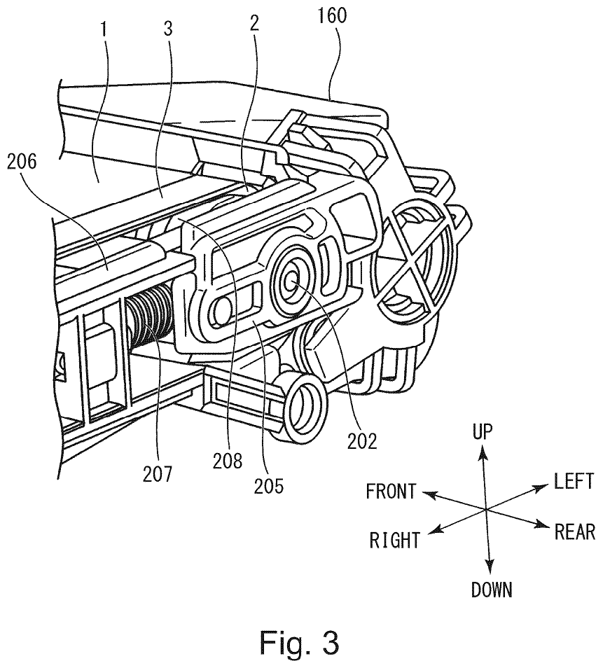

Next, the intermediary transfer unit 150 will be further described with reference to FIGS. 1 to 3. FIG. 2 is a schematic perspective view of the intermediary transfer unit 150 in this embodiment. FIG. 3 is a schematic perspective view showing the tension roller 202 and the neighborhood thereof in the intermediary transfer unit 150 in this embodiment in an enlarged manner.

The image forming apparatus 100 includes the intermediary transfer unit 150 as a belt conveying device provided opposed to the four photosensitive drums 101Y, 101M, 101C, and 101K.

The intermediary transfer unit 150 includes a frame 206, the stretching rollers 201 to 204, the primary transfer rollers 106Y, 106M, 106C, and 106K, the intermediary transfer belt 1, and the belt cleaning device 160. In this embodiment, the intermediary transfer unit 150 includes, as a plurality of stretching rollers, the driving roller 201, the tension roller 202, and the first and second auxiliary rollers 203 and 204. The frame 206 is a frame for supporting the stretching rollers 201 to 204, the primary transfer rollers 106Y, 106M, 106C, and 106K, and the like. The stretching rollers 201 to 204 and the primary transfer rollers 106Y, 106M, 106C, and 106K are rotatably supported by the frame 206. Rotational axis directions of the stretching rollers 201 to 204 and the primary transfer rollers 106Y, 106M, 106C, and 106K are substantially parallel to each other. The intermediary transfer belt 1 is stretched by the stretching rollers 201 to 204. The intermediary transfer unit 150 is constituted by integrally assembling these elements with each other. The intermediary transfer unit 150 as an exchange unit is constituted so as to be integrally removable from (detachably mountable to) the apparatus main assembly 120.

The driving roller 201 forms the secondary transfer portion T2 by sandwiching the intermediary transfer belt 1 between itself and the outer secondary transfer roller 107. The driving roller 201 also functions as the inner secondary transfer roller opposing the outer secondary transfer roller 107 via the intermediary transfer belt 1.

The first and second auxiliary rollers 203 and 204 form a primary transfer surface of the intermediary transfer belt 1 onto which the toner images are primarily transferred. The second auxiliary roller 204 has a crown shape such that with respect to a rotational axis direction thereof, an outer diameter thereof becomes a maximum at a substantially central portion and gradually becomes small toward each of opposite end portions thereof. This is for suppressing that the central portion of the second auxiliary roller 204 with respect to the rotational axis direction is flexed by tension of the intermediary transfer belt 1 and wrinkles occurs at the central portion of the intermediary transfer belt 1 with respect to the widthwise direction.

The tension roller 202 is rotatably supported by a bearing member 205 on each of opposite end portion sides thereof with respect to the rotational axis direction thereof. This bearing member 205 is mounted to the frame 206 so as to be movable (slidable). The bearing member 205 on each of the opposite end portion sides of the tension roller 202 is urged (pressed) from an inner peripheral surface side toward an outer peripheral surface side by an urging force (pressing force, compression force) of a tension spring 207 constituted by a compression spring which is an urging member as an urging means. Then, the bearing member 205 is moved (slid) from the inner peripheral surface side to the outer peripheral surface side of the intermediary transfer belt 1 along an urging direction by the tension spring 207. By this, the tension roller 202 urges the intermediary transfer belt 1 from the inner peripheral surface side toward the outer peripheral surface side of the intermediary transfer belt 1 and imparts tension to the intermediary transfer belt 1.

In each of the opposite end portions of the tension roller 202 with respect to the rotational axis direction, a restricting collar 208 as a restricting member for restricting a shift of the intermediary transfer belt 1 is provided (FIG. 2). The shift of the intermediary transfer belt 1 is a phenomenon such that the intermediary transfer belt 1 moves in the widthwise direction when the intermediary transfer belt 1 is rotated. On the inner peripheral surface of each of the opposite end portions of the intermediary transfer belt 1, a rib 2 as a member-to-be-restricted is provided on the inner peripheral surface of each of the opposite end portions of the intermediary transfer belt 1 with respect to the widthwise direction so as to project from this inner peripheral surface (FIG. 2). In this embodiment, the rib 2 has a substantially rectangular shape in cross section substantially perpendicular to an extension direction thereof, and is fixed to the inner peripheral surface of the intermediary transfer belt 1 by bonding. Further, in this embodiment, the rib 2 is provided over substantially full circumference of the intermediary transfer belt 1, and the end portions of the rib 2 with respect to the extension direction are opposite from each other. By contact of the rib 2 with the restricting collar 208, the shift of the intermediary transfer belt 1 is restricted. Further, in this embodiment, on the outer peripheral surface of the intermediary transfer belt 1 in each of the opposite end portions, a reinforcing tape (reinforcing member) 3 is provided (FIG. 3). In this embodiment, the reinforcing tape 3 is adhesively bonded to the outer peripheral surface of the intermediary transfer belt 1. Further, in this embodiment, the reinforcing tape 3 is provided over substantially full circumference of the intermediary transfer belt 1.

In this embodiment, the intermediary transfer belt 1 is constituted by a resin belt including a base layer of polyimide (PI). In this embodiment, the intermediary transfer belt 1 is 18,000 N/cm² in tensile elastic coefficient and 0.08 mm in thickness. Incidentally, the intermediary transfer belt 1 may desirably be constituted by a relatively high-rigidity resin such as polyvinylidene (di-fluoride (PVDF), polyamide, polyimide (PI), polyethylene terephthalate (PET), or polycarbonate. Further, the thickness of the intermediary transfer belt 1 may desirably fall within a range of 0.02 mm or more and 0.50 mm or less. When the thickness of the intermediary transfer belt 1 is excessively thin, there is a possibility that sufficient durability against abrasion cannot be obtained, and when the thickness of the intermediary transfer belt 1 is excessively thick, there is a possibility that the intermediary transfer belt 1 is not readily cured on the driving roller 201, the tension roller 202, and first and second auxiliary rollers 203 and 204 and thus deformation and folding thereof occur.

The belt cleaning device 160 includes a cleaning blade 161 as a cleaning member, a conveying screw 162 as a conveying member, and a cleaning container 163 as a casing (FIG. 1). The cleaning blade 161 is a plate-like member which has a predetermined length with respect to a longitudinal direction substantially parallel to a direction substantially perpendicular to a surface movement direction of the surface of the intermediary transfer belt 1 and with respect to a widthwise direction substantially perpendicular to the longitudinal direction, which has a predetermined thickness, and which is formed with an elastic member. The cleaning blade 161 is disposed opposed to the tension roller 202 via the intermediary transfer belt 1 at an angle where the cleaning blade 161 extends in a counter direction to the surface movement direction of the intermediary transfer belt 1. That is, the cleaning blade 161 is disposed so that an edge portion of a free end portion thereof with respect to the widthwise direction extends toward an upstream side with respect to the surface movement direction of the intermediary transfer belt 1. Further, the cleaning blade 161 is contacted to the surface of the intermediary transfer belt 1 at the edge portion of the free end portion with respect to the widthwise direction and applies an external force to the tension roller 202 via the intermediary transfer belt 1. The cleaning blade 161 is bonded and fixed to a supporting metal plate (not shown) as a supporting member at a fixed end portion thereof with respect to the widthwise direction thereof. Further, this supporting metal plate is fixed to the cleaning container 163 by screws or the like, whereby the cleaning blade 161 is supported by the cleaning container 163.

The collected matter such as the toner collected form the intermediary transfer belt 1 by the cleaning blade 161 is accommodated in a collected toner accommodating portion 163a formed in the cleaning container 163. In the collected toner accommodating portion 163a, a conveying screw 162 is provided. The conveying screw 162 conveys the collected matter such as the toner in the collected toner accommodating portion 163a toward one end portion (for example, the end portion on the front side) of the cleaning container 163 along the longitudinal direction of the belt cleaning device 160 (cleaning blade 161). Then, the collected matter such as the toner conveyed by the conveying screw 162 is discharged through a discharge opening (not shown) provided at the one end portion of the cleaning container 163, and is sent toward the residual toner conveying passage (not shown) provided in the apparatus main assembly 120. The collected matter sent to the residual toner conveying passage is conveyed to a residual toner container (not shown) detachably mounted in the apparatus main assembly 120. The residual toner container is exchanged when the residual toner container becomes full or the like.

The belt cleaning device 160 removes and collects the deposited matter such as secondary transfer residual toner from the surface of the intermediary transfer belt 1 by rubbing the surface of the intermediary transfer belt 1 with the cleaning blade 161. The cleaning blade 161 is contacted to a winding region in which the intermediary transfer belt 1 is wound around the tension roller 202. As described above, the direction of the free end of the cleaning blade 161 is the counterdirection to the surface movement direction of the intermediary transfer belt 1. The belt cleaning device 160 collects the deposited matter such as the secondary transfer residual toner by bringing the free end portion of the cleaning blade 161 into contact with the surface (outer peripheral surface) of the intermediary transfer belt 1. In this embodiment, the cleaning blade 161 is formed of an urethane rubber.

This urethane rubber is 75° in hardness in terms of JIS-A hardness and 2 mm in thickness. Further, in this embodiment, the cleaning blade 161 is 25° in contact angle and 3 N/m (30 gf/cm) in contact pressure. However, a constitution of the belt cleaning device 160 is not limited thereto.

The primary transfer roller 106 is pressed (urged) against the inner peripheral surface of the intermediary transfer belt 1 by a pressing constitution (not shown). By this, the primary transfer roller 106 forms the primary transfer portion T1 by pressing the intermediary transfer belt 1 toward the associated photosensitive drum 101. The intermediary transfer unit 1 includes bearing members (not shown) for rotatably supporting the primary transfer rollers 106Y, 106M, 106C, and 106K, and the first and second auxiliary rollers 203 and 204, respectively. These bearing members are constituted so as to be capable of moving the rollers in directions toward and away from a common contact flat surface on a side where the four photosensitive drums 101Y, 101M, 101C, and 101K contact the intermediary transfer belt 1. Further, the intermediary transfer unit 150 is provided with a moving mechanism (contact and separation mechanism) (not shown) for moving these bearing members.

In this embodiment, a stretching state of the intermediary transfer belt 1 is capable of being changed to the following first, second, and third states. In the first stretching state, all the primary transfer rollers 106Y, 106M, 106C, and 106K and the first and second auxiliary rollers 203 and 204 are disposed in a second position (separation position) where these rollers are separated from the contact flat surface. By this, the intermediary transfer belt 1 is separated from all the photosensitive drums 101Y, 101M, 101C, and 101K. Further, in the second stretching state, all the primary transfer rollers 106Y, 106M, 106C, and 106K and the first and second auxiliary rollers 203 and 204 are disposed in a second position (contact position) closer to the contact flat surface than the second position (separation position). By this, the intermediary transfer belt 1 contacts all the photosensitive drums 101Y, 101M, 101C, and 101K. Further, in the third stretching state, the primary transfer rollers 106Y, 106M, and 106C for yellow, magenta, and cyan, respectively, and the first auxiliary roller 203 are disposed in the above-described second position (separation position).

On the other hand, the primary transfer roller 106k for black and the second auxiliary roller 204 are disposed in the above-described first position (contact position). By this, the intermediary transfer belt 1 contacts only the photosensitive drum 101K for black of the four photosensitive drums 101Y, 101M, 101C, and 101K. For example, during stand-by for printing and during mounting and demounting of the intermediary transfer unit 150 relative to the apparatus main assembly 120, the intermediary transfer belt 1 is put in the above-described first stretching state. Further, for example, during color image printing, the intermediary transfer belt 1 is put in the above-described second stretching state. Further, for example, during monochromatic image printing during (black (monochromatic) image printing), the intermediary transfer belt 1 is put in the above-described third stretching state.

Further, in this embodiment, the intermediary transfer unit 150 is provided with a memory substrate 5 as a storing device. The memory substrate 5 provided to the intermediary transfer unit 150 will be described later.

### 3. Exchange of Intermediary Transfer Unit

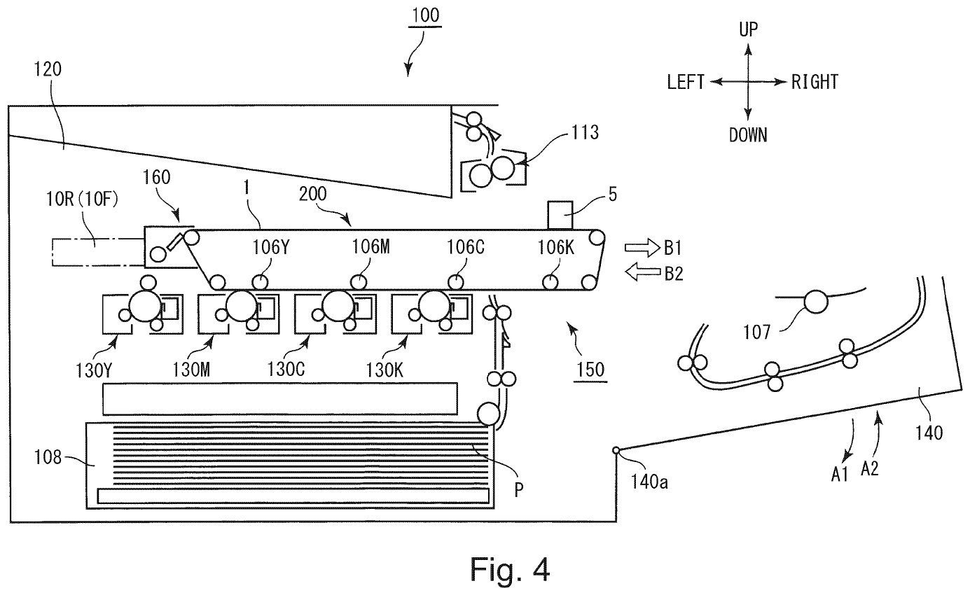

The intermediary transfer unit 150 is made detachably mountable to the apparatus main assembly 120. In this embodiment, the intermediary transfer unit 150 is constituted by including the belt cleaning device 160 and a frame unit 200 which is another constitution of the intermediary transfer unit 150 including the intermediary transfer belt 1. In this embodiment, the frame unit 200 is constituted by including the frame 206, the plurality of stretching rollers 201 to 204, the intermediary transfer belt 1, and the primary transfer rollers 106. Further, the intermediary transfer unit 150 is mounted in and demounted from the apparatus main assembly 120 in a state in which the belt cleaning device 160 is mounted to the frame unit 200. FIG. 4 is a schematic sectional view of the image forming apparatus 100 in this embodiment, showing a state in which the intermediary transfer unit 150 is mounted in and demounted from the apparatus main assembly 120.

As shown in FIG. 4, the image forming apparatus 100 includes a right door unit 140 as an openable member, for opening an inside of the apparatus main assembly 120, provided in a side portion on the right side. The right door unit 140 is constituted so as to be rotated about a rotation shaft 140a provided at a lower portion thereof and extending in the front-rear direction. Further, the right door unit 140 is opened by rotating an upper portion thereof downward (in an arrow A1 direction in FIG. 4) and is closed by rotating the upper portion thereof upward (in an arrow A2 direction opposite to the arrow A1 direction in FIG. 4). The right door unit 140 is opened and closed by operating a grip portion or the like provided thereon, by an operator such as a user or a service person. The right door unit 140 is opened so that at least a part of the conveying feeding passage of the recording material P from the recording material cassette 108 to the fixing device 113 via the secondary transfer portion T2 is divided into a front surface (onto which the toner image is transferred) side and a back surface side of the recording material P. The outer secondary transfer roller 107 is mounted on the right door unit 140 side.

When the right door unit 140 is opened, the outer secondary transfer roller 107 is spaced from the intermediary transfer belt 1. When the right door unit 140 is opened, the operator can access to the intermediary transfer unit 150 mounted in the apparatus main assembly 120. Then, the operator is capable of demounting the intermediary transfer unit 150 from the apparatus main assembly 120 by pulling out the intermediary transfer unit 150 toward the right side (in an arrow B1 direction in FIG. 4) by operating the grip portion or the like provided on the frame 206. On the other hand, the operator is capable of mounting the intermediary transfer unit 150 into the apparatus main assembly 120 by inserting the intermediary transfer unit 150 into the left side (in an arrow B2 direction opposite to the arrow B1 direction in FIG. 4). The intermediary transfer unit 150 is moved while being supported by the front rail 10F and the rear rail 10R which are rail-shaped mounting portions provided on a frame in the apparatus main assembly 120 (FIG. 1). Then, the intermediary transfer unit 150 is positioned and mounted in a predetermined position (mounting position) of the front rail 10F and the rear rail 10R (FIG. 1). In this embodiment, the intermediary transfer unit 150 is moved in a substantially horizontal direction, so that the intermediary transfer unit 150 is mounted and demounted (inserted and extracted).

In this embodiment, a lifetime of the intermediary transfer belt 1 is shorter than a lifetime of the apparatus main assembly 2. For that reason, the intermediary transfer belt 1 is capable of being exchanged to a new one by making the intermediary transfer unit 150 mountable in and demountable from the apparatus main assembly 120. Incidentally, the intermediary transfer belt 1 may be made exchangeable by exchanging only the intermediary transfer belt 1 for the frame unit 200 or may be exchanged together with the frame unit 200 or the intermediary transfer unit 150.

Further, in the case where a lifetime of the belt cleaning device 160 is shorter than a lifetime of the frame unit 200 or depending on a use method in the market, the toner on the intermediary transfer belt 1 is not readily removed by the belt cleaning device 160 in some instances. In such a case, the intermediary transfer unit 150 is not exchanged, but only the belt cleaning device 160 is exchanged, so that only a necessary part can be exchanged. For that reason, in this embodiment, the belt cleaning device 160 is made exchangeable to a new one by being made mountable to and demountable from the frame unit 200 of the intermediary transfer unit 150. FIG. 5 is a schematic perspective view of the intermediary transfer unit 150 in this embodiment, showing a state in which the belt cleaning device 160 is demounted from the frame unit 200. Thus, in this embodiment, in the intermediary transfer unit 150, the belt cleaning device 160 is made further mountable to and demountable from the frame unit 200 of the intermediary transfer unit 150. By this, only a minimum constitution is made exchangeable, so that it becomes possible to suppress an increase in running cost of the image forming apparatus 100.

Further, in this embodiment, in the case where the intermediary transfer unit 150 is not integrally exchanged but only the belt cleaning device 160 is exchanged singly, an information to that effect may be made inputtable from an operating portion 60 provided to the image forming apparatus main assembly 120. That is, in the case where only the belt cleaning device 160 is exchanged, the user is capable of inputting the information to the effect that only the belt cleaning device 160 is exchanged, by manual input from the operating portion 60. Further, a controller 50 may be constituted so as to perform a predetermined initializing operation before a start of image formation when the controller 50 detects, that only the belt cleaning device 160 is exchanged, by an input signal inputted from the operating portion 60. As this initializing operation, for example, an operation in which a toner bond is supplied as a lubricant to a contact portion between the cleaning blade 161 of the belt cleaning device 160 and the intermediary transfer belt 1 or the like operation would be considered. Further, in the case where the intermediary transfer unit 150 is integrally exchanged, a constitution in which the initializing operation is executed together with detection of a new intermediary transfer unit 150 on the basis of information stored in the memory substrate 5 may be employed.

### 4. Storing Device

Next, the memory substrate 5 as the storing device provided to the intermediary transfer unit 150 in this embodiment will be described. The memory substrate 5 includes a memory contact 5a which is a contact portion and a memory 5b which is a storing portion (FIG. 6).

In this embodiment, in the memory substrate 5, destination information of the intermediary transfer unit 150 is stored. The “destination information” is, for example, information for detecting (discriminating whether the intermediary transfer unit 150 provided with the memory substrate 5 is adapted to which image forming apparatus 100. The destination information is discrimination information enabling discrimination of existence/absence of compatibility of the intermediary transfer unit 150 with the apparatus main assembly 120. For example, intermediary transfer units 150 different in constitution are mountable to the same apparatus main assembly 120 in some cases. As an example, there is a case where an intermediary transfer unit 150 including a plurality of primary transfer rollers 106 (for example, primary transfer rollers 106Y, 106M, 106C, and 106K for yellow, magenta, cyan, and black) and capable of transfer of a multi-color toner image, and an intermediary transfer unit including only a single primary transfer roller 106 and incapable of the transfer of the multi-color toner image are mountable to the apparatus main assembly 120 of the same image forming apparatus 100. In this case, different pieces of destination information are inputted to the former memory substrate 5 and the latter memory substrate 5. The description information is recorded in the memory substrate 5 in a manufacturing step of the intermediary transfer unit 150, during factory shipping (during inspection) or the like. Specifically, the destination information may be independent information showing a destination of the intermediary transfer unit 150 or may be included as a part of a product number, an individual number or the like of the intermediary transfer unit 150. Further, in a main assembly storing portion 52 which is a storing portion of the controller 50 (FIG. 6) provided in the apparatus main assembly 120, “verification information” which is information enabling discrimination as to whether which intermediary transfer unit 150 is adapted to the image forming apparatus 100 is registered. The verification information is registered in the main assembly storing portion 52 in a manufacturing step of the image forming apparatus 100, during factory shipping (during inspection), or the like. Specifically, the verification information may be independent information compared with the destination information, may be included as a part of a product number, an individual number, or the like of the image forming apparatus 100, or may be included in a program for discriminating whether or not specific information is included in the destination information read from the memory substrate 5. The controller 50 checks the discrimination information possessed on the intermediary transfer unit 150 side against the verification information possessed on the image forming apparatus 100 side, so that the controller 50 is capable of discriminating whether or not discriminations thereof coincide with each other. Incidentally, an example in the case where the different pieces of information are stored in the memory substrate 5 is not limited to the above-described example. For example, it is possible to exemplify the case where a characteristic of a part such as the intermediary transfer belt is different between the intermediary transfer unit for the present model and an intermediary transfer unit for a successor model, but these intermediary transfer units are mountable to either one of apparatus main assembles for these models.

Further, in this embodiment, characteristic value information is stored in the memory substrate 5. The “characteristic value information” is information on intrinsic characteristic possessed by an element constituting the intermediary transfer unit 150. The characteristic value information is stored in the memory substrate 5, for example, in the manufacturing step of the intermediary transfer unit 150, during the factory shipping (during the inspection), or the like. For example, the intermediary transfer belt 1 has an intrinsic belt resistance value (electric resistance value) for each of products (models, product numbers), lots, or individuals in some instances. Further, it is desired in some instances that a primary transfer voltage and a secondary transfer voltage which are matched with the belt resistance value are set. In the case where it is unclear on the apparatus main assembly 120 side that an intermediary transfer unit 150 having what belt resistance value is mounted, the following operation is needed in some instances. For example, in order to set an optimum primary transfer voltage or secondary transfer voltage, before the image formation is carried out, there is a need to perform an adjusting operation of several stages by detecting the belt resistance value. Therefore, when the belt resistance value is preliminarily stored as the characteristic value information in the memory substrate 5, the controller 50 is capable of reading the belt resistance value from the memory substrate 5 when the intermediary transfer unit 150 is mounted in the apparatus main assembly 120. By this, it becomes possible that the above-described adjusting operation for setting the optimum primary transfer voltage or secondary transfer voltage is made unnecessary or is simplified. The same applies to electric resistance values of the primary transfer member and the secondary transfer member. By storing the characteristic value information in the memory substrate 5, it becomes possible to carry out operation control or management of the image forming apparatus 100 optimum for each of products (medals, product numbers), lots, or individuals, so that operation stability and improvement in quality of the image forming apparatus 100 can be realized.

Further, in this embodiment, in the memory substrate 5, use history information which is information on a use history of the intermediary transfer unit 150 in the image forming apparatus 100 is stored. The “use history information” is information such as a number of sheets of the recording materials P subjected to printing using the intermediary transfer unit 150 in the image forming apparatus 100, or a ratio between a monochromatic image and a color image. For example, the controller 50 acquires a cumulative value of the number of sheets printed (may be a number of sheets converted into that of a predetermined size) as an index value relating to a use amount of the intermediary transfer belt 1 from a start of the use of the intermediary transfer belt 1 (during a new article state), and then updates and stores the value thereof in the memory substrate 5. Incidentally, the index value may only be required to be a value correlating with the use amount of the intermediary transfer belt 1 with the operation of the image forming apparatus 100. For example, a print time, a conveyance distance (or number of rotations) or a conveyance time of the intermediary transfer belt 1, or the like may be used. Further, the controller 50 acquires the index value relating to each of those during monochromatic image printing and during color image printing and thus acquires a ratio between a monochromatic image and clear image, so that the controller is capable of updating and storing the index value in the memory substrate 5. Incidentally, a method of acquiring information on the ratio between the monochromatic image and the color image is not limited to the above-described method. It becomes possible to take countermeasures such that when the intermediary transfer unit 150 collected from the market is reproduced, on the basis of the above-described use history information, a part low in use frequency is re-utilized and only a part close to an end of a lifetime thereof is exchanged to a new part.

Incidentally, in the case where the intermediary transfer belt 1 is exchanged to a new article (in the case where the new article is detected), the controller 50 may be configured so as to enable that at least a part (for example, the number of sheets printed) of the use history information is reset to an initial value (for example, zero). Further, the controller 50 may be configured so as to enable that at least a part (for example, the number of sheets printed) of the use history information is notified (displayed or the like) for the purpose of being used as an index of an exchange timing of the intermediary transfer belt 1. This notification can be performed by the operating portion 60 (FIG. 6) provided to the apparatus main assembly 120 or in an external device depending on a predetermined operation by an operator through the operating portion 60 or in the external device, or in a predetermined timing. Further, in the case where at least a part (for example, the number of sheets printed) of the use history information exceeds a predetermined threshold or in the like case, information prompting the operator to exchange the intermediary transfer belt 1 may be automatically notified (displayed or the like).

### 5. Control Constitution

FIG. 6 is a schematic block diagram showing a control constitution of the image forming apparatus 100 in this embodiment. The apparatus main assembly 120 of the image forming apparatus 100 is provided with the controller 50 for integrally controlling respective portions of the image forming apparatus 100. The controller 50 includes a CPU 51 which is a dominant element for performing arithmetic processing as an arithmetic control means, and the main assembly storing portion 52 which is a storing portion (storing medium) such as a ROM and a RAM which are used as storing means. In the ROM, a control program, a data table acquired in advance and the like are stored. In the RAM, information inputted to the controller 50, detected information, a calculation result and the like are stored. Further, the controller 50 is provided with an input/output circuit (input/output portion) (not shown) for receiving and transmitting signals between the controller 50 and respective portions.

To the controller 50, the respective portions (the image forming portions S, and the driving devices, various power sources, various sensors and the like for members such as the intermediary transfer belt 1 and conveying members for conveying the recording material P) of the image forming apparatus 100 are connected. Further, to the controller 50, a counter 70 as a counting means for counting the number of sheets printed as the use history information of the intermediary transfer unit 15 is connected. Further, to the controller 50, a reading/writing circuit (reading/writing portion) 80 for reading/writing information from/in the memory substrate 5 provided to the intermediary transfer unit 150 is connected. To the reading/writing circuit 80, a contact spring 6a as a contact member provided to a contact holder 6 described later is connected. Further, to the controller 50, the operating portion (operating panel) 60 provided to the apparatus main assembly 120 is connected. The operating portion 60 includes a display portion (display means) for displaying information by control of the controller 50 and includes an input portion (input means) for inputting information to the controller 50 on the basis of an operation by the operator such as the user or the service person. The operating portion 60 may also be constituted by including a touch panel having functions of the display means and the input means. Further, to the controller 50, an image reading device (not shown) an external device (not shown) such as a personal computer, connected to the image forming apparatus 1 may also be connected.

### 6. Arrangement of Memory Substrate

### <Outline of Arrangement of Memory Substrate>

Next, an arrangement of the memory substrate 5 provided to the intermediary transfer unit 150 in this embodiment will be described.

FIG. 2 is a schematic perspective view of the intermediary transfer unit 150 in this embodiment, and FIG. 5 is a schematic perspective view of the intermediary transfer unit 150 in this embodiment in a state the belt cleaning device 160 is demounted from the frame unit 200.

As described above, the intermediary transfer unit 150 is constituted by including the belt cleaning device 160 and the frame unit 200. Further, as described above, the intermediary transfer unit 150 is constituted so as to be capable of demounting the belt cleaning device 160 from the frame unit 200.

Further, in this embodiment, as shown in FIG. 5, the memory substrate 5 is provided on a frame unit 200 side of the belt cleaning device 160 and the frame unit 200 which constitute the intermediary transfer unit 150.

As described above, in the intermediary transfer unit 150 to which the belt cleaning device 160 is detachably mountable, when the memory substrate 5 is mounted to the belt cleaning device 160, in the case where the belt cleaning device 160 was exchanged, a use history on the frame unit side becomes unclear. On the other hand, as in this embodiment, by providing a memory substrate 5 on the frame unit 200 side, even in the case where the belt cleaning device 160 is exchanged in the market, the use history on the frame unit 200 side can be continuously left in the memory substrate 5.

Further, as shown in FIG. 3, in this embodiment, the belt cleaning device 160 is mounted to the bearing member 205 of the tension roller 202. For that reason, the belt cleaning device 160 is slid and moved in interrelation with the bearing member 205 imparting tension to the intermediary transfer belt 1. In such a constitution, when the memory substrate 5 is provided to the belt cleaning device 160, the following problem can arise. That is, when the intermediary transfer unit 150 is set in the apparatus main assembly 120, there is a possibility that the tension imparted to the intermediary transfer belt 1 becomes weak by an urging force from a spring for urging the contact holder provided on the apparatus main assembly 120 side or from a contact spring as a contact member. On the other hand, as in this embodiment, the memory substrate 5 on the frame unit 200 side, the memory substrate 5 can be provided to the intermediary transfer unit 150 without having the influence on the tension imparted to the intermediary transfer belt 1.

As described above, by providing the memory substrate 5 on the frame unit 200 side, even in the case where the belt cleaning device 160 is exchanged, the use history no the frame unit 200 side where the number of constituent ports is larger than that on the belt cleaning device 160 side can be left in the memory substrate 5. By this, even in the case, when a part of the frame unit 200 of the intermediary transfer unit 150, which is collected from the market is re-utilized, it becomes possible to take countermeasure such that a part low in use frequency is re-utilized and only a part close to an end of a lifetime thereof is exchanged to a new part. That is, a part which is not required to be exchanged is continuously used, so that it becomes possible to provide an environmentally-friendly intermediary transfer unit 150.

<Position of Memory Substrate with Respect to Front-Rear Direction>

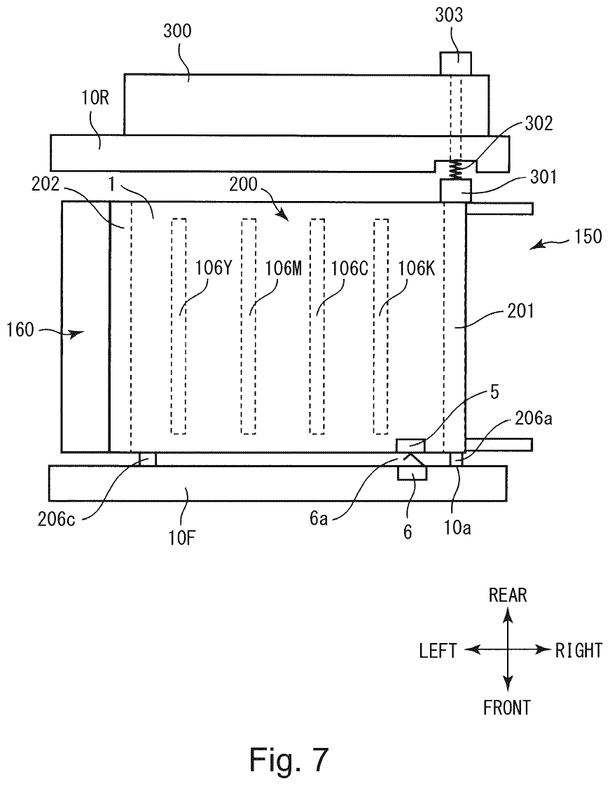

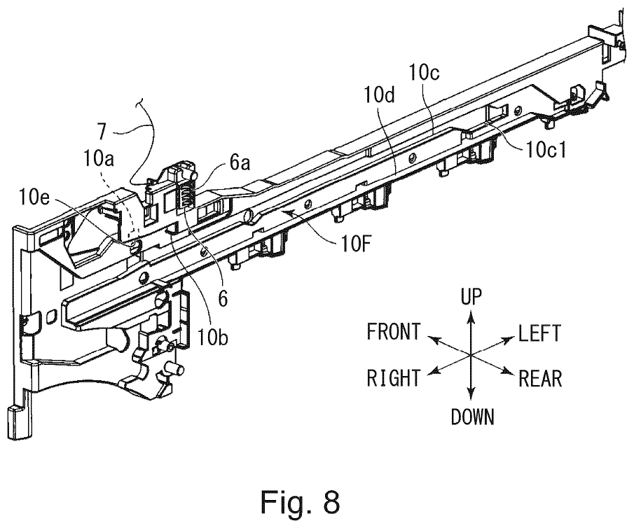

Next, a position of the memory substrate 5, with respect to a front-rear direction, provided to the intermediary transfer unit 150 in this embodiment will be described. FIG. 7 is a schematic view of a neighborhood of the intermediary transfer unit 150 disposed in a predetermined position (mounting position) in the apparatus main assembly 120, as viewed from above. Further, FIG. 8 is a perspective view of a neighborhood of the front rail 10F provided in the apparatus main assembly 120.

As shown in FIG. 7, to frames on a front side and a rear side in the apparatus main assembly 120, the front rail 10F and the rear rail 10R which are rail-shaped mounting portions for mounting the intermediary transfer unit 150 are provided, respectively. Further, as shown in FIG. 7, to the rear-side frame in the apparatus main assembly 120, a driving unit 300 is provided. The driving unit 300 is provided with a driving gear 301 as a drive transmission member for transmitting a driving force to the driving roller 201, an urging spring 302 which is an urging member as a gear urging member as an urging means for urging the driving gear 301, and a driving motor 303 as a driving source. The driving gear 301 is urged in a direction from the rear side toward the front side by the gear urging spring 302. When the intermediary transfer unit 150 is mounted in the apparatus main assembly 120, the driving gear 301 is connected to a drive-receiving gear (not shown) provided in a rear-side end portion of the driving roller 201. In this embodiment, with movement of the intermediary transfer unit 150, the driving gear 301 is retracted against the urging force of the gear urging spring 302 by the intermediary transfer unit 150, and thereafter, that state is released, so that the driving gear 301 is connected to the drive-receiving gear. The intermediary transfer unit 150 is urged toward the front side by the driving gear 301 (specifically, via the driving gear 301 and the driving roller 201 by the gear urging spring 302). Further, when the driving motor 303 is rotated, the driving force is transmitted to the driving roller 201 via the driving gear 301, so that the intermediary transfer belt 1 is rotated.

Further, as shown in FIG. 8, the front rail 10F is provided with the contact holder 6 as a contact holding member for holding the contact member on the apparatus main assembly 120 side. In this embodiment, the contact holder 6 is formed integrally with the front rail 10F. That is, in this embodiment, the contact holder 6 is fixedly provided to the apparatus main assembly 120 (front rail 10F) so as not to be moved relative to the apparatus main assembly 120 (front rail 10F). The contact holder 6 is provided with the contact spring 6a as the contact member for being electrically connected (conducted) to the memory substrate 5. The contact spring 6a is provided so as to project from the front side toward the rear side and so as to be elastically deformable in the front-rear direction. Further, in this embodiment, correspondingly to the memory contact 5a of the memory substrate 5, a plurality of contact springs 6a are arranged and provided in an up-down direction. The contact holder 6 is provided in a position where the memory contact 5a and the contact spring 6a are connected to each other so as to be electrically conductable when the intermediary transfer unit 150 is mounted in the apparatus main assembly 120. The contact spring 6a is connected to the reading/writing circuit 80 (FIG. 6), provided in the apparatus main assembly 120, via an electric bundle wire provided in the apparatus main assembly 120.

Further, as shown in FIGS. 2 and 7, the memory substrate 5 is provided to a front-side side portion structure 261 of the frame 206 in the frame unit 200 of the intermediary transfer unit 150. Thus, the memory substrate 5 is provided in a side portion (end portion) of the frame unit 200 with respect to a direction crossing (in this embodiment, substantially perpendicular to) an insertion direction (mounting direction) of the intermediary transfer unit 150 into the apparatus main assembly 120. Incidentally, the insertion direction (arrow B2 direction of FIG. 5) of the intermediary transfer unit 150 into the apparatus main assembly 120 is also referred simply to as a “unit insertion direction”. In this embodiment, the unit insertion direction is a direction crossing (in this embodiment, substantially perpendicular to) the widthwise direction (rotational axis directions of the plurality of stretching rollers 201 to 204) of the intermediary transfer belt 1, and is substantially horizontal. Particularly, in this embodiment, the memory substrate 5 is provided in the front-side side portion of the frame unit 200 with respect to the direction crossing (in this embodiment, substantially perpendicular) the unit insertion direction. That is, in this embodiment, the memory substrate 5 is provided in the side portion of the frame unit 200 on a side opposite from a side, where the driving gear 301 (gear urging spring 302) for urging the intermediary transfer unit 150, with respect to the direction crossing (in this embodiment, substantially perpendicular to the unit insertion direction. The memory substrate 5 is fixed to a memory holding portion 263 formed integrally with the front-side side portion structure 261 of the frame 206. That is, in this embodiment, the memory substrate 5 is fixedly provided to the memory holding portion 263 of the frame 206 so as not to be moved relative to the frame 206. The memory substrate 5 is provided with the memory contact 5a as the contact portion for being electrically connected (conducted) to the contact spring 6a on the apparatus main assembly 120. The memory contact 5a of the memory substrate 5 is directed frontward. Further, the memory contact 5a is fixedly provided so as not to move on the memory substrate 5. Further, in this embodiment, a plurality of memory contacts 5a are arranged and provided in the up-down direction. The memory contacts 5a and the contact springs 6a are contacted to each other, so that the controller 50 is capable of writing/reading information in/from the memory substrate 5 via the reading/writing circuit 80.

Further, as shown in FIGS. 2 and 7, the front-side side portion structure 261 of the frame 206 is provided with a projection 206a as a front-rear direction positioning portion on the intermediary transfer unit 150 side. Further, as shown in FIGS. 7 and 8, the front rail 10F is provided with a contact portion 10a, as a front-rear direction positioning portion on the apparatus main assembly 120 side, against which the projection 206a is capable of abutting. When the intermediary transfer unit 150 is mounted in the apparatus main assembly 120, the intermediary transfer unit 150 is urged toward the front side by the driving gear 301. Then, the projection 206a abuts against the contact portion 10a, so that the intermediary transfer unit 150 is positioned with respect to the front-rear direction.

Thus, by providing the memory substrate 5 to the side portion of the frame unit 200 with respect to the direction crossing the unit insertion direction a structure of a connecting portion between the contact member on the apparatus main assembly 120 side and the memory substrate 5 on the intermediary transfer unit 150 side can be simplified. That is, for example, in the case where the memory substrate memory substrate is provided in the belt cleaning device at a free end of the intermediary transfer unit with respect to the insertion direction, the following constitution is needed in some instances. The belt cleaning device is mounted coaxially with (for example, on the bearing member) the rotation axis of the stretching roller for the intermediary transfer belt in some instances. For example, in the case where the stretch roller is the tension roller or a steering roller, the belt cleaning device is moved in interrelation with movement of the stretching roller. In order to realize such movement of the belt cleaning device, it is required in some cases that the contact holder on the apparatus main assembly side is made movable relative to the frame or the like of the apparatus main assembly or that the memory holding member on the intermediary transfer unit side is made movable relative to a main body of the intermediary transfer unit. In addition, it is required in some instances that the contact holder on the apparatus main assembly side and the memory holding member on the intermediary transfer unit side are urged by springs. On the other hand, the side portion of the frame unit 200, for example, the side portion structure of the frame 206 is not substantially moved in a state in which the intermediary transfer unit 150 is mounted in the apparatus main assembly 120. For that reason, in the case where the memory substrate 5 is provided in the side portion of the frame unit 200 with respect to the direction crossing the unit insertion direction, it is possible to realize simplification of the connecting portion between the contact holder 6 on the apparatus main assembly 120 side and the memory substrate 5 on the intermediary transfer unit 150 side. Further, the urging forces from the spring for urging the contact holder 6 on the apparatus main assembly 120 side and from the contact spring as the contact member have no influence on the tension imparted to the intermediary transfer belt 1.

Particularly, in this embodiment, the intermediary transfer unit 150 is urged toward the front side by the driving gear 301 and thus the projection 206a is abutted against the contact portion 10a of the front rail 10F, so that the intermediary transfer unit 150 is positioned with respect to the front-rear direction. By this, in a state in which the memory substrate 5 is urged toward the front side, the memory contact 5a and the contact spring 6a can be connected to each other. Further, without providing a constitution for urging the contact holder 6 by another spring provided separately or the like, the memory contact 5a and the contact spring 6a can be sufficiently connected with each other.

<Position of Memory Substrate with Respect to Left-Right Direction>

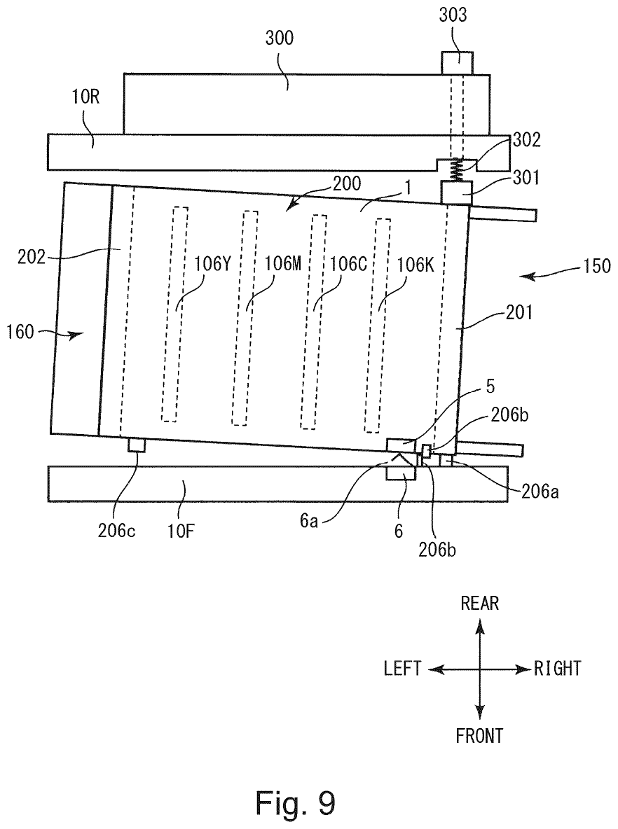

Next, a position of the memory substrate 5, with respect to a left-right direction, provided to the intermediary transfer unit 150 in this embodiment will be described. FIG. 9 is a schematic view of a neighborhood of the intermediary transfer unit 150, provided in the apparatus main assembly 120, as viewed from above, and shows a tendency of a fluctuation in attitude of the intermediary transfer unit 150 in an exaggerated manner.

In this embodiment, as described above, the image forming apparatus 100 includes the driving gear 301 (gear urging spring 302) as a means for urging the intermediary transfer unit 150 toward the front side. This driving gear 301 is positioned on a side (right side) upstream a center of the frame unit 200 (specifically, the frame 206, the same applies hereafter) in the intermediary transfer unit 150 disposed in a predetermined position (mounting position) in the apparatus main assembly 120 with respect to the unit insertion direction. That is, with respect to the unit insertion direction, the driving roller 201 is positioned on the side (right side) upstream of the frame unit 200. Incidentally, in this embodiment, as a means for urging the intermediary transfer unit 150 toward the front side, the image forming apparatus 100 includes the following means in addition to the driving gear 301 (gear urging spring 302). First, there is a contact member (not shown) for applying a primary transfer voltage to each of the primary transfer rollers 106. Further, there is a moving mechanism driving gear (not shown) for transmitting drive to the above-described moving mechanism for moving each of the primary transfer rollers 106 or the like. These members including the contact member for applying the primary transfer voltage and the moving-mechanism driving gear are provided on the rear-side side portion structure 262 side of the frame 206 of the frame unit 200 in the apparatus main assembly 120. However, in this embodiment, of urging forces applied to the intermediary transfer unit 150 by the respective means for urging the intermediary transfer unit 150 toward the front side, the urging force applied to the intermediary transfer unit 150 by the driving gear 301 is largest.

For that reason, as shown in FIG. 9, the right side of the intermediary transfer unit 150 is put in a state of abutment thereof against the front rail 10F. However, on a left side of the intermediary transfer unit 150, a force for urging the intermediary transfer unit 150 toward the front side is weak, and therefore, there is a possibility that the left side of the intermediary transfer unit 150 does not abut against the front rail 10F. Accordingly, when the memory substrate 5 is disposed on a side (left side) downstream of the center of the frame unit 200 with respect to the unit insertion direction, there is a possibility that the following phenomenon occurs. That is, there is a possibility that the memory contact 5a and the contact spring 6a cannot be connected to each other or that connection between these portions 5a and 6a becomes unstable.

On the other hand, in this embodiment, the memory substrate 5 is disposed on the side (right side) upstream of the center of the frame unit 200 with respect to the unit insertion direction. That is, in this embodiment, with respect to the unit insertion direction, the memory substrate 5 is disposed on the same side as a side where the driving gear 301 is provided, relative to the center of the frame unit 200. Thus, in this embodiment, with respect to the unit insertion direction, relative to the center of the frame unit 200, the memory substrate 5 is disposed on the same side as a position where the intermediary transfer unit 150 is abutted against the front rail 10F by the urging force of the driving gear 301. For that reason, the memory contact 5a and the contact spring 6a can be connected to each other is a more stable position.

Incidentally, with respect to the unit insertion direction, the memory substrate 5 may preferably disposed on a side (right side) upstream of the rotation axis of the primary transfer roller 106K positioned most upstream (most downstream with respect to the rotational direction of the intermediary transfer belt 1). In this embodiment, with respect to the unit insertion direction, the memory substrate 5 is disposed on the side (right side) upstream of the rotation axis of the primary transfer roller 106K positioned most upstream and on the side (left side) downstream of the rotation axis of the driving roller 201. By this, the memory substrate 5 becomes close to an urging position of the memory substrate 5 toward the front side by the driving gear 301, and therefore, connection between the memory contact 5a and the contact spring 6a is further stabilized.

Further, in this embodiment, as shown in FIGS. 2 and 9, the front-side side portion structure 261 of the frame 206 is provided with an abutting portion 206b as a left-right direction positioning portion on the intermediary transfer unit 150 side. The abutting portion 206b is provided adjacent to the memory substrate 5 on the side (right side) upstream of the memory substrate with respect to the unit insertion direction. Further, as shown in FIGS. 8 and 9, the front rail 10F is provided with a restricting portion 10b, as a left-right direction positioning portion on the apparatus main assembly 120 side, against which the abutting portion 206b is capable of abutting. When the intermediary transfer unit 150 is mounted in the apparatus main assembly 120, the abutting portion 206b abuts against the restricting portion 10b, so that the intermediary transfer unit 150 is positioned with respect to the left-right direction. At this time, the abutting portion 206b and the memory substrate 5 may further preferably be disposed on a side (right side) upstream of the rotational axis of the primary transfer roller 106 positioned most upstream and on a side (left side) downstream of the rotational axis of the driving roller 201 with respect to the unit insertion direction. By this, the memory substrate 5 is disposed in the neighborhood of a position where positioning of the intermediary transfer unit 150 with respect to the left-right direction is performed, and therefore, the memory contact 5a and the contact spring 6a can be connected to each other in a further stable position.

Incidentally, it is also preferable from another viewpoint, below that the memory substrate 5 is disposed on a side (right side) upstream of the center of the frame unit 200 with respect to the unit insertion direction. That is, with respect to the unit insertion direction, the memory substrate 5 is disposed on the side (right side) upstream of the center of the frame unit 200, so that compared with the case where the memory substrate 5 is disposed on the downstream side (left side), a movement distance of the memory substrate 5 in the apparatus main assembly 120 when the intermediary transfer unit 150 is mounted in and demounted from the apparatus main assembly 120 becomes short. By this, a possibility of occurrence of inconveniences due to contact of the memory substrate 5 with a member in the apparatus main assembly 120, or the like when the intermediary transfer unit 150 is mounted in and demounted from the apparatus main assembly 120 can be reduced.

<Position of Memory Substrate with Respect to Up-Down Direction>

Next, a position of the memory substrate 5, with respect to the up-down direction, provided to the intermediary transfer unit 150 in this embodiment will be described.

As described above, when the intermediary transfer unit 150 is mounted in and demounted from the apparatus main assembly 120, the intermediary transfer unit 150 is moved while being supported by the front rail 10F and the rear rail 10R.

As shown in FIG. 2, the front-side side portion structure 261 of the frame 206 is provided with a positioning boss 206c, a guiding boss 206d, a positioning surface 206e, and a guiding surface 206f. With respect to the unit insertion direction, the guiding boss 206d is provided in the neighborhood of a downstream-side end portion, and the positioning boss 206c is provided upstream of an adjacent to this guiding boss 206d. The guiding boss 206d and the positioning boss 206c are provided so as to project toward an outside of the intermediary transfer unit 150 along a direction crossing (in this embodiment, substantially perpendicular to) the unit insertion direction.

Further, with respect to the unit insertion direction, in the neighborhood of an upstream-side end portion, the positioning surface 206e and the guiding surface 206f are provided on an upper side and a lower side, respectively, while sandwiching the driving roller 201 therebetween. Further, as shown in FIG. 8, the front rail 10F is provided with an upper rail portion 10c and a lower rail portion 10d along the unit insertion direction on a side surface on the intermediary transfer unit 150 side (rear side).

Incidentally, the rear-side side portion structure 262 of the frame 206 is also provided with a positioning boss 206c, a guiding boss 206d, a positioning surface 206e, and a guiding surface 206f which have a constitution similar to (substantially symmetrical, with respect to a plane passing through a center (line) of the intermediary transfer belt 1 with respect to the widthwise direction and substantially perpendicular to the surface of the intermediary transfer belt 1, with) a constitution of those provided to the above-described front-side side portion structure 261. Further, the rear rail 10R is also provided with an upper rail portion 10c and a lower rail portion 10d which have a constitution similar to (substantially symmetrical, with respect to the plane passing through the center of the intermediary transfer belt 1 with respect to the widthwise direction and substantially perpendicular to the surface of the intermediary transfer belt 1, with) a constitution of those provided to the above-described front rail 10F.

Further, the intermediary transfer unit 150 is moved toward the left side in a state being supported by the front rail 10F and the rear rail 10R in a manner such that the guiding boss 206d and the positioning boss 206c are placed on the lower rail portion 10d and the upper rail portion 10c, respectively. Further, in a downstream-side end portion with respect to the unit insertion direction, the positioning boss 206c falls into a positioning recessed portion 10cl provided on the upper rail portion 10c, so that the intermediary transfer unit 150 is positioned with respect to the up-down direction. Further, in an upstream-side end portion with respect to the unit insertion direction, the intermediary transfer unit 150 is moved to the left side in a state in which the guiding surface 206f is supported by the lower rail portion 10d. Further, as described above, the abutting portion 206b of the frame 206 abuts against the restricting portion 10b of the front rail 10F (and the rear rail 10R), so that the intermediary transfer unit 150 is positioned with respect to the left-right direction. Further, at this time, as described above, the driving gear 301 is connected to the drive receiving gear (not shown) of the driving roller 201, so that the intermediary transfer unit 150 is urged toward the front side. By this, the projection 206a of the frame 206 abuts against the contact portion 10a of the front rail 10F, so that the intermediary transfer unit 150 is positioned with respect to the front-rear direction. Further, in the upstream-side end portion with respect to the unit insertion direction, the intermediary transfer unit 150 is positioned with respect to the up-down direction in the following manner. That is, the right door unit 140 is closed, and thus the outer secondary transfer roller 107 is contacted to the driving roller 201 via the intermediary transfer belt 1, so that the intermediary transfer unit 150 is urged toward an upper side. By this, the positioning surface 206e of the frame 206 contacts the restricting surface 10e of the front rail 10F (and the rear rail 10R). Thus, the intermediary transfer unit 150 is positioned with respect to the up-down direction.

Here, in this embodiment, until immediately before the abutting portion 206b abuts against the restricting portion 10b and until immediately before the projection 206a abuts against the contact portion 10a, the memory contact 5a is disposed in a contactable position to the contact spring 6a or is contacted to the contact spring 6a. Then, the abutting portion 206b abuts against the restricting portion 10b and the projection 206a abuts against the contact portion 10a, so that the memory contact 5a and the contact spring are sufficiently connected to each other. Further, a constitution in which even when the right door unit 140 is closed and the neighborhood of the driving roller 201 of the intermediary transfer unit 150 is urged toward the upper side, the connecting state between the memory contact 5a and the contact spring 6a is maintained is employed.

Incidentally, an operation when the intermediary transfer unit 150 is demounted from the apparatus main assembly 120 is an operation reverse to the above-described operation when the intermediary transfer unit 150 is inserted (mounted) into the apparatus main assembly 120.

Thus, the intermediary transfer unit 150 has a projection-shaped portion such as the positioning boss 206c. When the memory substrate 5 is disposed inside an outer configuration of the intermediary transfer belt 1, the position of the contact spring 6a, with respect to the up-down direction, provided to the contact spring 6a is inside the outer configuration of the intermediary transfer belt 1. In the case, there is a possibility that the projection-shaped portion such as the positioning boss 206c is caught by the contact spring 6a and deforms the contact spring 6a when the intermediary transfer unit 150 is mounted in and demounted from the apparatus main assembly 120. The outer configuration of the intermediary transfer belt 1 is an outer configuration in the case where the intermediary transfer belt 1 stretched by the plurality of stretching rollers 201 to 204 when the intermediary transfer unit 150 is mounted and demounted from the apparatus main assembly 120 is viewed in a direction substantially parallel to the widthwise direction of the intermediary transfer belt 1. An outer configuration of a portion of the frame 206 other than the memory holding portion 263 in the case where the portion is viewed in the direction substantially parallel to the widthwise direction of the intermediary transfer belt 1 is made the same as the outer configuration of the intermediary transfer belt 1 for the purpose of facilitating mounting/demounting the intermediary transfer belt 1 in/from the apparatus main assembly 120.

Therefore, in this embodiment, the contact spring 6a is disposed outside a locus along which a portion of the frame unit 200 other than the memory holding portion 263 passes when the intermediary transfer unit 150 is mounted in and demounted from the apparatus main assembly 120. Particularly, in this embodiment, for the reason described later, the contact spring 6a is disposed on an upper side than the locus along which the portion of the frame unit 200 other than the memory holding portion 263 passes when the intermediary transfer unit 150 is mounted in and demounted from the apparatus main assembly 120 (FIG. 8). Further, in this embodiment, the memory substrate 5 is disposed in a position corresponding to the position of the contact spring 6a.

In order to suppress interference of the projection-shaped portion such as the positioning boss 206c with the contact spring 6a, the contact spring 6a may only be required to be disposed outside a movement locus of the projection-shaped portion in the apparatus main assembly 120 when the intermediary transfer unit 150 is mounted in and demounted from the apparatus main assembly 120. In this embodiment, in order to more securely suppress that the projection-shaped portion such as the positioning boss 206c is caught by the contact spring 6a, the contact spring 6a is disposed outside the outer configuration of the intermediary transfer belt 1. Particularly, in this embodiment, the contact spring 6a is disposed on an upper side than the outer configuration of the intermediary transfer belt 1 (FIG. 8). Further, in this embodiment, correspondingly to the position of the contact spring 6a, the memory substrate 5 is disposed outside the outer configuration of the intermediary transfer belt 1. Particularly, in this embodiment, the memory substrate 5 is disposed on an upper side than the outer configuration of the intermediary transfer belt 1 (FIG. 2). In this embodiment, a whole of the memory substrate 5 is disposed outside the outer configuration of the intermediary transfer belt 1 (in this embodiment, is disposed on the upper side than the outer configuration of the intermediary transfer belt 1). However, at least a part of the memory substrate 5 may only be required to be disposed outside the outer configuration of the intermediary transfer belt 1 (in this embodiment, be disposed on the upper side than the outer configuration of the intermediary transfer belt 1) so that the projection-shaped portion such as the positioning boss 206c can be sufficiently suppressed from being caught by the contact spring 6a.

By this, it is possible to suppress that the projection-shaped portion such as the positioning boss 206c is caught by the contact spring 6a when the intermediary transfer unit 150 is mounted in and demounted from the apparatus main assembly 120. Further, by disposing the memory substrate 5 on the upper side than the outer configuration of the intermediary transfer belt 1, the memory substrate 5 can be disposed in a position (on a side opposite from the image forming portion S while sandwiching the intermediary transfer belt 1 therebetween) apart from the developing device 104 while sandwiching the intermediary transfer belt 1 therebetween. In the image forming portion S including the photosensitive drum 101 and the developing device 104, the toner scattered from the developing device 104 is scattered in some instances. For that reason, the memory substrate 5 is disposed on the upper side than the outer configuration of the intermediary transfer belt 1 and is disposed in the position away from the developing device 104 while sandwiching the intermediary transfer belt 1 therebetween, so that deposition of the toner onto the memory substrate 5 can be suppressed.

### <Relationship Between Mounting/Demounting Direction of Intermediary Transfer Belt and Position of Memory Substrate>

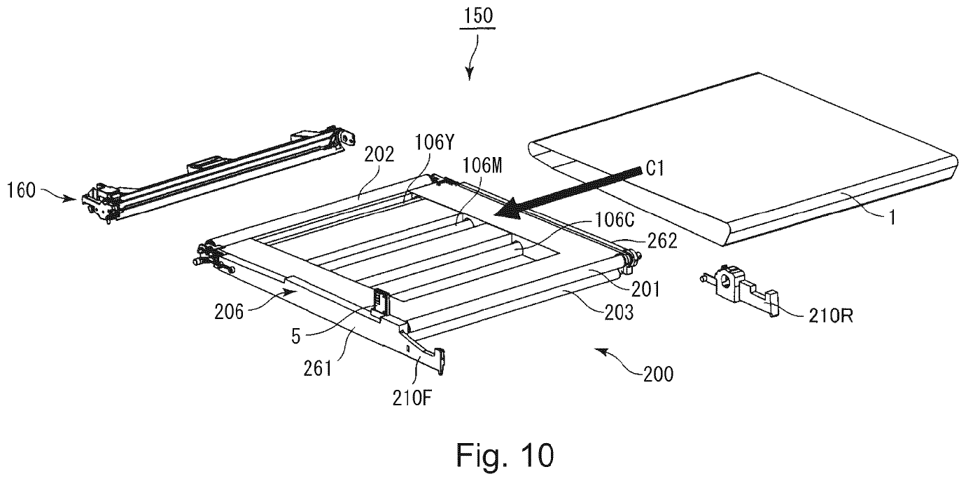

Next, a relationship between the mounting/demounting direction of the intermediary transfer belt 1 relative to the frame 206 and the position of the memory substrate 5 will be described. FIG. 10 is an exploded perspective view of the intermediary transfer unit 150, showing a state when the intermediary transfer belt 1 is assembled with the frame 206.

When the intermediary transfer belt 1 is assembled with the frame 206, the frame 206 is put in a state in which the driving roller 201, the first and second auxiliary rollers 203 and 204, and the respective primary transfer rollers 106Y, 106M, 106C, and 106K are assembled with the frame 206. On the other hand, at this time, the frame 206 is put in a state in which the rear-side bearing member 205 of the tension roller 202, the tension roller 202, the belt cleaning device 160, and a rear-side grip 210R are demounted from the frame 206. Incidentally, the frame 206 is provided with grips 210F and 210R, provided in right-side end portions of the front-side side portion structure 261 and the rear-side side portion structure 262, respectively, for being operated by the operator when the intermediary transfer unit 150 is mounted in and demounted from the apparatus main assembly 120. The grips 210F and 210R are provided so as to project toward a side (right side) upstream of the outer configuration of the intermediary transfer belt 1 with respect to the unit insertion direction. Further, in order to mount/demount the intermediary transfer belt 1 to/from the frame 206, the rear-side grip 210R is made detachably mountable to the rear-side side portion structure 262. The front-side grip 210F is formed integrally with the front-side side portion structure 261. The intermediary transfer belt 1 is moved substantially parallel to the widthwise direction thereof in a direction, indicated by an arrow C1 in FIG. 10, from the rear side toward the front side.

In order to assemble the endless intermediary transfer belt 1 with the frame 206, there is a need that an outer peripheral length of the frame 206 is shorter than an inner peripheral length of the intermediary transfer belt 1 when the frame 206 is viewed in a direction substantially parallel to the widthwise direction of the intermediary transfer belt 1. Here, as described above, in this embodiment, the memory substrate 5 is disposed outside the outer configuration of the intermediary transfer belt 1.

Therefore, in this embodiment, the memory substrate 5 is disposed on a downstream side (front side) in an assembling direction (arrow C1 direction in FIG. 10) of the intermediary transfer belt 1 with the frame 206. By this, the memory substrate 5 can be disposed to the frame unit 200 without having the influence on the insertion and extraction of the intermediary transfer belt into and from the frame unit 200.

From a state shown in FIG. 10, the intermediary transfer belt 1 is assembled with the frame 206, and thereafter, the tension roller 202 (and the rear-side bearing member 205), the rear-side grip 210R, and the belt cleaning device 160 are assembled with the frame 206. By this, the intermediary transfer unit 150 is completed.

Incidentally, an operation when the intermediary transfer belt 1 is demounted from the frame 206 is an operation reverse to the above-described operation during the assembling.

Thus, in this embodiment, the image forming apparatus 100 includes the image forming portion S for forming the a toner image on the image bearing member (photosensitive drum) 101; the intermediary transfer unit 150 for transferring the toner image, formed by the image forming portion S onto the recording material position and provided with the frame unit 200 including the intermediary transfer belt 1 onto which the toner image is transferred from the image bearing member 101, the plurality of stretching rollers 201 to 204 for stretching the intermediary transfer belt 1, and the frame 206 for supporting the plurality of stretching rollers 201 to 204; the cleaning device (belt cleaning device) 160 for removing the toner from the surface of the intermediary transfer belt 1; and the memory substrate 5 including the storing portion 5b and the contact portion 5a; and includes the contact member 6a connectable to the contact portion 5a of the memory substrate 5. Further, in this embodiment, the intermediary transfer unit 150 is detachably mountable to the apparatus main assembly 120 of the image forming apparatus 100. The cleaning device 160 is detachably mountable to the frame unit 200. The intermediary transfer unit 150 is constituted so as to be mounted in and demounted from the apparatus main assembly 120 in a state in which the cleaning device 160 is mounted to the frame unit 200. The memory substrate 5 is provided to the frame unit 200. Further, in this embodiment, the memory substrate 5 is provided in the side portion of the frame unit 200 with respect to the direction crossing the insertion direction of the intermediary transfer unit 150 into the frame unit 200. Further, in this embodiment, the memory substrate 5 is provided so that the contact portion 5a is directed toward the outside of the intermediary transfer unit with respect to the direction crossing the insertion direction. Further, in this embodiment, the image forming apparatus 100 includes the urging means (driving gear) 301 for uniting the intermediary transfer unit 150, provided in the predetermined position in the apparatus main assembly 120, from one side portion side toward the other side portion side of the frame unit 200 with respect to the direction crossing the insertion direction. With respect to the insertion direction, the memory substrate 5 is provided in the side portion of the frame unit 200 on the side opposite from the side where the urging means 301 is provided. Further, in this embodiment, the insertion direction is the direction crossing the widthwise direction of the intermediary transfer belt 1, and the plurality of stretching rollers 201 to 204 in the driving roller 201 for driving the intermediary transfer belt 1, and the urging means 301 is the drive transmitting member (driving gear) 301 for transmitting the driving force to the driving roller 201. In this embodiment, the driving roller 201 is positioned on the side upstream of the center of the frame unit 200 with respect to the insertion direction, and the memory substrate 5 is positioned on the side upstream of the center of the frame unit 200 with respect to the insertion direction.

Further, in this embodiment, the image forming apparatus 100 includes the plurality of image forming portion S. The frame unit 200 includes the plurality of primary transfer rollers 106, each for transferring the toner image from an associated one of image bearing members 101 onto the intermediary transfer belt 1, provided correspondingly to the plurality of image forming portions S, respectively, and along the widthwise direction of the intermediary transfer belt 1. With respect to the insertion direction, the memory substrate 5 is provided on the side upstream of the rotational axis of the primary transfer roller 106K, positioned on the most upstream side of the plurality of primary transfer rollers 106, and downstream of the rotational axis of the driving roller 201.

Further, in this embodiment, the frame unit 200 includes the positioning portion (abutting portion) 206b for determining the position thereof in the apparatus main assembly 120 with respect to the insertion direction of the intermediary transfer unit 150 by abutment against the apparatus main assembly 120. With respect to the insertion direction, the positioning portion 206b is positioned on the side upstream of the rotational axis of the primary transfer roller 106K positioned on the most upstream side and downstream of the rotational axis of the driving roller 201. Further, in this embodiment, the frame unit 200 includes the projection (positioning boss) 206c supported by the apparatus main assembly 120 when the intermediary transfer unit is inserted into the apparatus main assembly 120 and provided so as to project toward the outside of the frame unit 200. The contact member 6a is positioned outside the movement locus of the projection 206c in the apparatus main assembly 120 when the intermediary transfer unit 150 is inserted into the apparatus main assembly 120. Further, in this embodiment, the memory substrate 5 is positioned outside the outer configuration of the intermediary transfer belt 1 stretched by the plurality of stretching rollers 201 to 204. Further, in this embodiment, the memory substrate 5 is positioned on the side opposite from the image forming portion S while sandwiching the intermediary transfer belt between itself and the image forming portion S in the apparatus main assembly 120. Further, in this embodiment, the memory substrate 5 is positioned on the downstream side of the assembling direction of the intermediary transfer belt 1 with the frame 206.

As described above, according to this embodiment, by mounting the memory substrate 5 to the frame unit 200 side, even in the case where the belt cleaning device 160 is exchanged, the use history of the frame unit 200 side can be left in the memory substrate 5. By this, it becomes easy to re-utilize a reusable in the frame unit 200 collected from the market. For that reason, it is possible to provide an environmentally-friendly intermediary transfer unit 150. Thus, in this embodiment, in the constitution in which the belt cleaning device is detachably mountable to the frame unit of the intermediary transfer unit, even in the case where the belt cleaning device is exchanged, it becomes possible to acquire information on the use history of the frame unit 200 side. Further, according to this embodiment, by providing the memory substrate in the side portion of the intermediary transfer unit with respect to the direction crossing the unit insertion direction, it is possible to realize simplification of the constitution of the connecting portion between the memory substrate on the intermediary transfer unit side and the contact member on the apparatus main assembly side of the image forming apparatus.

### Embodiment 2

Next, another embodiment of the present disclosure will be described. Basic constitution and operation of an image forming apparatus of this embodiment are the same as those of the image forming apparatus in the embodiment 1. Accordingly, elements having identical or corresponding functions or constitutions to those of the image forming apparatus of the embodiment 1 are represented by the same reference numerals or symbols as those in the embodiment 1 and will be omitted from detailed description.

In this embodiment, some modified embodiments relating to an arrangement of the memory substrate 5, or the like will be described.

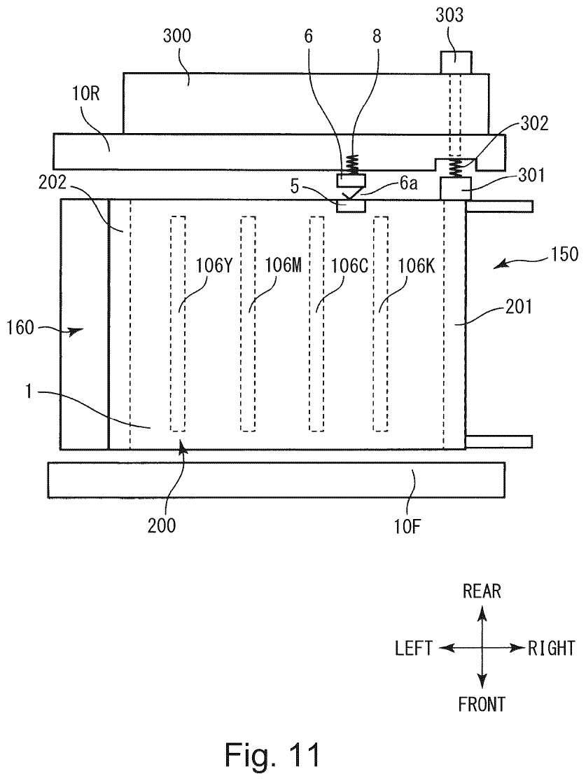

In the embodiment 1, in the constitution in which the driving gear 301 for urging the intermediary transfer unit 150 toward the front side, the constitution in which the memory substrate 5 is disposed on the front side was described. On the other hand, a constitution in which the memory substrate 5 is disposed on the rear side can also be employed. FIG. 11 is a schematic view of a neighborhood of the intermediary transfer unit 150 in an example of such a constitution, as viewed from above. In this modified embodiment, the memory substrate 5 is provided on the rear-side side portion of the frame unit 200, and the contact holder 6 is provided on the rear rail 10R. Further, in this modified embodiment, the rear rail 10R is provided with a contact urging spring 8 which is an urging member as a contact member urging means for urging the contact holder 6. Further, the contact holder 6 is urged toward the front side by the contact urging spring 8 and is moved toward the frame unit 200. The contact holder 6 may also be contacted to the frame unit 200.

By this, even in the case where the intermediary transfer unit 150 is urged toward the front side by the driving gear 301, the contact urging spring 8 sufficiently extends, so that it is possible to sufficiently connect the memory contact 5a and the contact spring 6a. Thus, with respect to the direction crossing the unit insertion direction, the memory substrate 5 may also be provided in a side portion of the frame unit 200 on the same side as a side where the urging means for urging the intermediary transfer unit 150 from one side-portion side toward the other side-portion side of the frame unit 200 in the direction crossing the unit insertion direction is provided. Further, the image forming apparatus 100 may include a contact member urging means (contact urging spring) 8.

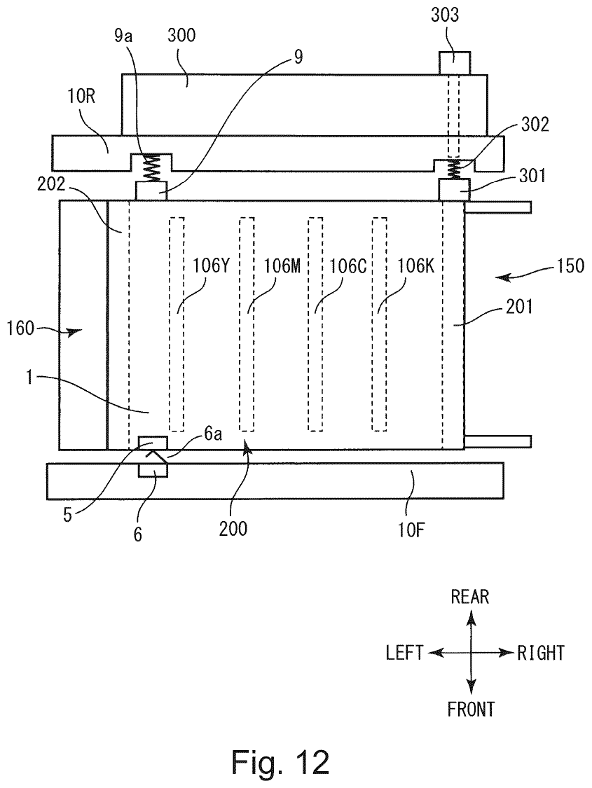

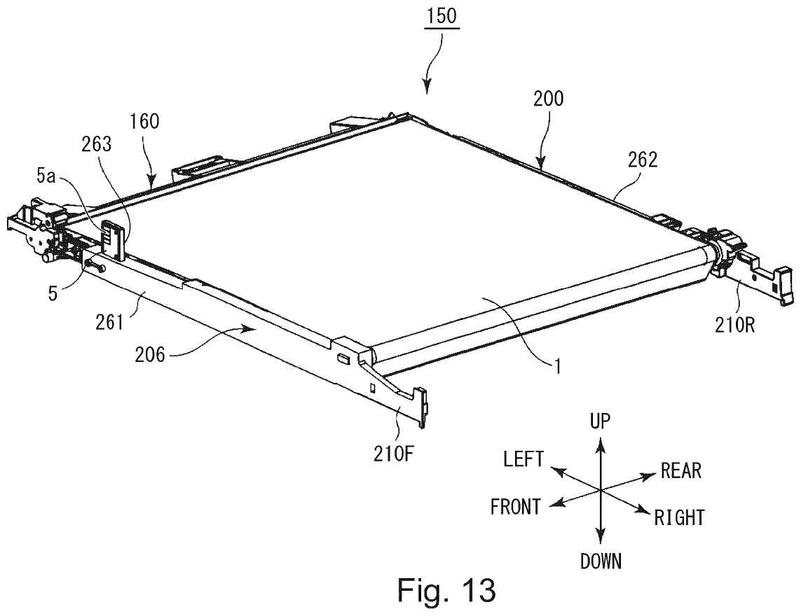

Further, in the embodiment 1, in the constitution in which with respect to the unit insertion direction the driving gear 301 for urging the intermediary transfer unit 150 toward the front side is provided on the upstream side (right side) than the center of the frame unit 200, the constitution in which the memory substrate 5 is disposed on the upstream side (right side) than the center of the frame unit 200 was described. On the other hand, it is also possible to employ a constitution in which the memory substrate 5 is disposed on the downstream side (left side) than the center of the frame unit 200. FIG. 12 is a schematic view of a neighborhood of the intermediary transfer unit 150 in a modified embodiment having such a constitution as viewed from above. Further, FIG. 13 is a schematic perspective view of the intermediary transfer unit 150 in this modified embodiment. In this modified embodiment, the memory substrate 5 is provided in the front-side side portion of the frame unit 200, and the contact holder 6 is provided on the front rail 10F. Further, in this modified embodiment, the driving gear 301 for urging the intermediary transfer unit 150 toward the front side is provided on the upstream side (right side) than the center of the frame unit 200 with respect to the unit insertion direction. Further, in this modified embodiment, on the downstream side (left side) than the center of the frame unit 200 with respect to the unit insertion direction, a driving roller 9 for urging the intermediary transfer unit 150 toward the front side is provided. This urging roller 9 is urged toward the front side by a roller urging spring 9a. By this, the intermediary transfer unit 150 can be abutted against the front rail 10F even on the downstream side (left side) with respect to the unit insertion direction. Accordingly, in a state in which the memory substrate 5 is urged toward the state side, in a stable position, the memory contact 5a and the contact spring 6a can be connected to each other.

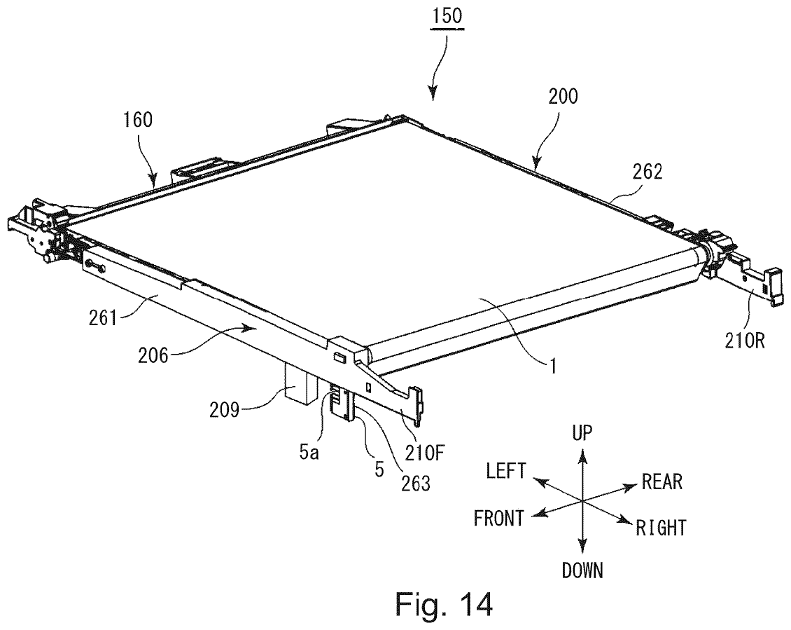

Further, in the embodiment 1, the constitution in which the memory substrate 5 is disposed on the upper side than the outer configuration of the intermediary transfer belt 1 was described. On the other hand, it is also possible to employ a constitution in which the memory substrate 5 is disposed on a lower side (the same side as the image forming portion S relative to the intermediary transfer belt 1) than the outer configuration of the intermediary transfer belt 1. In such a constitution, for example, a flow of air in the image forming apparatus 100 is adjusted and movement of the toner leaked from the developing device 104 is sufficiently suppressed, so that it is possible to suppress deposition of the toner onto the memory substrate 5. Further, FIG. 14 is a schematic perspective view of an intermediary transfer unit 150 in another example of the constitution in which the memory substrate 5 is disposed on the lower side than the outer configuration of the intermediary transfer belt 1. In this modified embodiment, in the neighborhood of the memory substrate 5, a wall 209 as a shielding means is provided. This wall 209 is provided on the front-side side portion structure 261 of the frame 206 between the image forming portion S and the memory substrate 5. By this, even in the constitution in which the memory substrate 5 is disposed on the lower side than the outer configuration of the intermediary transfer belt 1, deposition of the toner onto the memory substrate 5 can be suppressed.

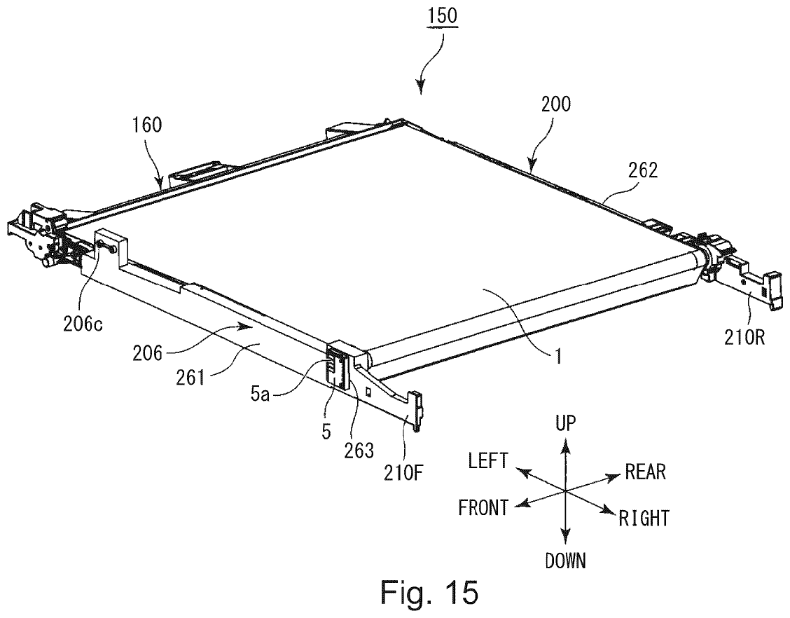

Further, in the embodiment 1, the constitution in which the memory substrate 5 is disposed on the upper side than the outer configuration of the intermediary transfer belt 1 was described. On the other hand, it is also possible to employ a constitution in which the memory substrate 5 is disposed inside the outer configuration of the intermediary transfer belt 1. FIG. 15 is a schematic perspective view of an intermediary transfer unit 150 in an example having such a constitution. In this modified embodiment, the memory substrate 5 is provided on the side surface of the front-side side portion structure 261 of the frame 206. Further, in this modified embodiment, the positioning boss 206c is disposed on the upper side than the outer configuration of the intermediary transfer belt 1. Also, in this modified embodiment, the contact spring 6a is disposed outside the locus along which the projection-shaped portion such as the positioning boss 206c passes when the intermediary transfer unit 150 is mounted in and demounted from the apparatus main assembly 120, and the memory substrate 5 is disposed in a position corresponding to a position of the contact spring 6a. By this, it is possible to suppress that the positioning boss 206c is caught by the contact spring 6a when the intermediary transfer unit 150 is mounted in and demounted from the apparatus main assembly 120. Thus, the memory substrate 5 may be positioned inside the outer configuration of the intermediary transfer belt 1 stretched by the plurality of stretching rollers 201 to 204. Further, also in this case, the contact member 6a can be configured to be positioned outside a movement locus of the projection (positioning boss) 206c, supported by the apparatus main assembly 120, in the apparatus main assembly 120 when the intermediary transfer unit 150 is mounted in and demounted from the apparatus main assembly 120.

Further, in the embodiment 1, in the constitution in which the belt cleaning device 160 is mounted to and demounted from the frame unit 200, the constitution in which the memory substrate 5 is provided on the frame unit 200 side was described. By employing such a constitution, even in the case where the belt cleaning device 160 is exchanged, such an effect that a use history of the frame unit 200 side can be left in the memory substrate 5 can be obtained. However, an effect obtained by providing the memory substrate 5 in the side portion (end portion) of the frame unit 200 with respect to the direction crossing the unit insertion direction can also be obtained in a constitution in which the belt cleaning device 160 is not made detachably mountable to the frame unit 200. In this case, similarly as in the embodiment 1, the memory substrate 5 may preferably be provided in the (front-side) side portion of the frame unit 200 with respect to the direction crossing the unit insertion direction, i.e., in the side portion on the side opposite from the side where the driving gear 301 (gear urging spring 302) for urging the intermediary transfer unit 150 is provided. Further, similarly as in the embodiment 1, the memory substrate 5 may preferably be disposed outside the outer configuration of the intermediary transfer belt 1. Also, as regards other constitutions, it is possible to employ a constitution in conformity to the constitution in the embodiment 1. Here, on the assumption that the intermediary transfer unit 150 is constituted so as not to readily demount the cleaning device 160 from the frame unit 200, description in the embodiment 1 will be referred to.

The technology described herein is capable of contributing to realization of a sustainable society such as decarbonized/recycling-oriented society.

According to the present disclosure, in the constitution in which the belt cleaning device is mounted to and demounted from the frame unit of the intermediary transfer unit, even in the case where the belt cleaning device is exchanged, it becomes possible to acquire information on the use history of the frame unit side.

Further, according to the present disclosure, by providing the memory substrate in the side portion of the intermediary transfer unit, it is possible to realize simplification of the constitution of the connecting portion between the memory substrate on the intermediary transfer unit side and the contact member on the apparatus main assembly side of the image forming apparatus.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Applications Nos. 2024-090333 filed on Jun. 3, 2024, and 2025-064654, filed on Apr. 9, 2025, which are hereby incorporated by reference herein in their entirety.

What is claimed is:

1. An image forming apparatus comprising:
at least one image forming portion configured to form a toner image on an image bearing member; and
an intermediary transfer unit onto which the toner image formed on the image bearing member is transferred and from which the transferred toner image is transferred onto a recording material, the intermediary transfer unit including:
a frame unit including an intermediary transfer belt onto which the toner image is transferred from the image bearing member, a plurality of stretching rollers for stretching the intermediary transfer belt, and a frame for supporting the plurality of stretching rollers;
a cleaning unit detachably mountable to the frame unit and configured to remove toner from a surface of the intermediary transfer belt; and
a memory substrate provided on the frame unit and including a storing portion for storing information.

2. An image forming apparatus according to claim 1, wherein the memory substrate is disposed outside the intermediary transfer belt with respect to a belt width direction crossing a movement direction of the intermediary transfer belt.

3. An image forming apparatus according to claim 2, wherein the memory substrate includes a contact portion connectable to a contact member provided in the main assembly, the contact portion being provided toward an outside of the intermediary transfer unit with respect to the belt width direction.

4. An image forming apparatus according to claim 1, further comprising urging means configured to urge the intermediary transfer unit, provided in a predetermined position in the main assembly, from one side portion side toward the other side portion side of the frame unit with respect to a belt width direction crossing a movement direction of the intermediary transfer belt,
wherein with respect to the belt width direction, the memory substrate is provided in a side portion of the frame unit on a side opposite from a side where the urging means is provided.

5. An image forming apparatus according to claim 4, wherein the plurality of stretching rollers include a driving roller for rotating the intermediary transfer belt, and
wherein the urging means is a drive transmitting member for transmitting a driving force to the driving roller.

6. An image forming apparatus according to claim 5, wherein the driving roller is positioned on a side upstream of a center of the frame unit with respect to an insertion direction of the intermediary transfer unit, and
wherein the memory substrate is positioned on a side upstream of the center of the frame unit with respect to the insertion direction.

7. An image forming apparatus according to claim 6, wherein the at least one image forming portion comprises a plurality of image forming portions,
wherein the frame unit includes a plurality of primary transfer rollers, each for transferring a toner image from an associated one of image bearing members onto the intermediary transfer belt, provided correspondingly to the plurality of image forming portions, respectively, and along the belt width direction, and
wherein with respect to the insertion direction of the intermediary transfer unit, the memory substrate is positioned on a side upstream of a rotational axis of the primary transfer roller, positioned on a most upstream side of the plurality of primary transfer rollers, and downstream of a rotational axis of the driving roller.

8. An image forming apparatus according to claim 7, wherein the frame unit includes a positioning portion for determining a position of the intermediary transfer unit in the main assembly with respect to the insertion direction of the intermediary transfer unit by abutment against the main assembly, and
wherein with respect to the insertion direction, the positioning portion is positioned on the side upstream of the rotational axis of the primary transfer roller positioned on the most upstream side and downstream of the rotational axis of the driving roller.

9. An image forming apparatus according to claim 1, wherein the memory substrate is positioned on a side upstream of a center of the frame unit with respect to an insertion direction of the intermediary transfer unit.

10. An image forming apparatus according to claim 1, wherein the frame unit includes a projection supported by the main assembly when the intermediary transfer unit is inserted into the main assembly and provided so as to project toward an outside of the frame unit in a widthwise direction of the intermediary transfer belt, and
wherein the image forming apparatus further comprises a contact member provided in the main assembly and connectable to a contact portion of the memory substrate, and the contact member is positioned outside a movement locus of the projection in the main assembly when the intermediary transfer unit is inserted into the main assembly.

11. An image forming apparatus according to claim 1, wherein as viewed in a belt width direction crossing a movement direction of the intermediary transfer belt, the memory substrate is positioned outside an outer configuration of the intermediary transfer belt stretched by the plurality of stretching rollers.

12. An image forming apparatus according to claim 11, wherein as viewed in the belt width direction crossing the movement direction of the intermediary transfer belt, the memory substrate is positioned on a side opposite from the image forming portion while sandwiching the intermediary transfer belt between itself and the at least one image forming portion.

13. An image forming apparatus according to claim 1, wherein as viewed in a belt width direction crossing a movement direction of the intermediary transfer belt, the memory substrate is positioned inside an outer configuration of the intermediary transfer belt stretched by the plurality of stretching rollers.

14. An image forming apparatus according to claim 13, wherein the frame unit includes a projection supported by the main assembly when the intermediary transfer unit is inserted into the main assembly and provided so as to project toward an outside of the frame unit in a widthwise direction of the intermediary transfer belt, and a contact member provided in the main assembly and connectable to a contact portion of the memory substrate, and
wherein the contact member is positioned outside a movement locus of the projection in the main assembly when the intermediary transfer unit is inserted into the main assembly.

15. An image forming apparatus according to claim 1, wherein the memory substrate is positioned on a side downstream of the frame with respect to an assembling direction of the intermediary transfer belt to the frame.

16. An image forming apparatus according to claim 1, further comprising an operating portion from which a user is capable of manually inputting a message that the cleaning unit is exchanged,
a controller configured to execute a predetermined initializing operation in a case where the message that the cleaning unit is exchanged is inputted from the operating portion.

17. An image forming apparatus according to claim 16, wherein the controller is configured to execute the predetermined initializing operation on the basis of the information stored in the memory substrate in a case where the intermediary transfer unit is a new intermediary transfer unit.

18. An image forming apparatus comprising:
an image forming portion configured to form a toner image on an image bearing member; and
an intermediary transfer unit detachably mountable to a main assembly of the image forming apparatus, onto which the toner image formed on the image bearing member is transferred, and from which the transferred toner image is transferred onto a recording material, the intermediary transfer unit including:
an intermediary transfer belt onto which the toner image is transferred from the image bearing member;
a plurality of stretching rollers configured to stretch the intermediary transfer belt;
a frame configured to support the plurality of stretching rollers; and
a memory substrate provided on the frame so as to be disposed outside the intermediary transfer belt with respect to a belt width direction crossing a movement direction of the intermediary transfer belt, and including a storing portion for storing information.

19. An intermediary transfer unit comprising:
a frame unit including an intermediary transfer belt onto which a toner image is transferred, a plurality of stretching rollers for stretching the intermediary transfer belt, and a frame for supporting the plurality of stretching rollers;
a cleaning unit detachably mountable to the frame unit and configured to remove toner from a surface of the intermediary transfer belt; and
a memory substrate provided on the frame unit and including a storing portion for storing information.

20. An intermediary transfer unit comprising:
an intermediary transfer belt onto which a toner image is transferred;
a plurality of stretching roller configured to stretch the intermediary transfer belt;
a frame configured to support the plurality of stretching rollers; and
a memory substrate provided on the frame so as to be disposed outside the intermediary transfer belt with respect to a belt width direction crossing a movement direction of the intermediary transfer belt, and including a storing portion for storing information.
